(19) United States
(12) Patent Application Publication
(10) Pub. No.: US 2026/0251828 A1
(43) Pub. Date: Aug. 27, 2026

(54) LIQUID CRYSTAL DIFFRACTION ELEMENT AND OPTICAL DEVICE

(71) Applicant: FUJIFILM Corporation, Tokyo (JP)

(72) Inventors: Hiroshi SATO, Minamiashigara-shi (JP); Takashi YONEMOTO, Minamiashigara-shi (JP); Takeharu TANI, Minamiashigara-shi (JP)

(73) Assignee: FUJIFILM Corporation, Tokyo (JP)

(21) Appl. No.: 19/649,138

(22) Filed: Apr. 16, 2026

Related U.S. Application Data
(63) Continuation of application No. PCT/JP2024/041468, filed on Nov. 22, 2024.

(30) Foreign Application Priority Data
Nov. 29, 2023 (JP) 2023-201487

(51) Int. Cl. G02B 5/18

(52) U.S. Cl. CPC G02B 5/1833

(57) ABSTRACT

A liquid crystal diffraction element includes a cholesteric liquid crystal layer having an alignment pattern in which an optical axis derived from a liquid crystal compound continuously rotates in-plane. A length of one rotation period of the alignment pattern is reduced to improve diffraction characteristics. The cholesteric liquid crystal layer includes a region at at least one surface in which the liquid crystal compound is tilted with respect to the surface, and includes a plurality of regions in which the tilt angle varies in-plane. An optical device including the liquid crystal diffraction element is also provided.

### CROSS-REFERENCE TO RELATED APPLICATIONS

This application is a Continuation of PCT International Application No. PCT/JP2024/041468 filed on Nov. 22, 2024, which claims priority under 35 U.S.C. § 119(a) to Japanese Patent Application No. 2023-201487 filed on Nov. 29, 2023. The above applications are hereby expressly incorporated by reference, in their entirety, into the present application.

### BACKGROUND OF THE INVENTION

### 1. Field of the Invention

The present invention relates to a liquid crystal diffraction element used in a head-mounted display or the like, and an optical device including the liquid crystal diffraction element.

### 2. Description of the Related Art

Display devices such as augmented reality (AR) glasses and head-mounted displays (HMDs) have been proposed as means for providing virtual reality (VR) to an observer. These display devices are relatively small, are easy to carry and wear, and are expected to be qmultifunctional devices that can replace smartphones, tablets, and the like.

As an example of a diffraction element used in the display device, a reflective structure using a cholesteric liquid crystal layer obtained by fixing a cholesteric liquid crystalline phase, which is described in WO2016/194961A, is exemplified.

WO2016/194961A describes a reflective structure including a plurality of helical structures each of which extends along a predetermined direction, in which the reflective structure includes a first incident surface that intersects the predetermined direction and on which light is incident, and a reflecting surface that intersects the predetermined direction and reflects the light incident from the first incident surface, and the reflecting surface is not parallel to the first incident surface.

### SUMMARY OF THE INVENTION

In short, the reflective structure (cholesteric liquid crystal layer) described in WO2016/194961A has a liquid crystal alignment pattern in which the orientation of the optical axis derived from the liquid crystal compound changes while continuously rotating along at least one in-plane direction, and thus, can diffract incident circularly polarized light and reflect circularly polarized light more inclined with respect to the incident direction.

Here, in an optical system of a display device such as a head-mounted display, further thinning and an increase in field of view are required. In order to achieve the thinning of the optical system and the increase in field of view, it is necessary to increase a diffraction angle of light on an end part side in a reflective type diffraction element. In a reflective type liquid crystal diffraction element including a cholesteric liquid crystal layer such as the reflective structure described in WO2016/194961A, in a case where a length over which the orientation of the optical axis derived from the liquid crystal compound rotates by 180° along one in-plane direction is set as one period, the diffraction angle of light can be increased by shortening the one period.

However, in a case where the length of the one period is shortened, there is a problem in that a diffraction efficiency is lowered. In particular, in a high diffraction angle region where the length of the one period is as short as a level of 1 μm, the diffraction efficiency is deteriorated, and a sufficient diffraction efficiency cannot be obtained.

An object of the present invention is to solve the above-described problem in the related art, and to provide a liquid crystal diffraction element having a liquid crystal alignment pattern in which, even in a case where a length of one period over which the orientation of the optical axis derived from the liquid crystal compound changes while continuously rotating along one in-plane direction is short, a diffraction efficiency is excellent in a liquid crystal alignment pattern of a reflective type liquid crystal diffraction element. Another object of the present invention is to provide an optical device including the liquid crystal diffraction element.

In order to achieve this object, the present invention has the following configurations.

[1]

A liquid crystal diffraction element comprising a cholesteric liquid crystal layer, in which the cholesteric liquid crystal layer has a liquid crystal alignment pattern in which a direction of an optical axis derived from a liquid crystal compound changes while continuously rotating along at least one direction in-plane, and the cholesteric liquid crystal layer has, on at least one surface of the cholesteric liquid crystal layer, a region where the liquid crystal compound has a tilt angle with respect to a surface of the cholesteric liquid crystal layer, and a region where the tilt angle of the liquid crystal compound with respect to the surface of the cholesteric liquid crystal layer differs in-plane.

[2]

The liquid crystal diffraction element according to [1], in which, in a case where a length over which the direction of the optical axis derived from the liquid crystal compound rotates by 180° in-plane is defined as one period, the cholesteric liquid crystal layer has a region where the length of the one period in the liquid crystal alignment pattern differs in-plane.

[3]

The liquid crystal diffraction element according to [2], in which the length of the one period in the liquid crystal alignment pattern gradually changes along the one direction, and the tilt angle of the liquid crystal compound gradually changes along the one direction.

[4]

The liquid crystal diffraction element according to [3], in which the tilt angle of the liquid crystal compound increases along the one direction as the length of the one period in the liquid crystal alignment pattern decreases along the one direction.

[5]

The liquid crystal diffraction element according to any one of [1] to [4], in which, in a cross-sectional image obtained by observing, with a scanning electron microscope, a cross section cut along the one direction and a thickness direction of the cholesteric liquid crystal layer, the cholesteric liquid crystal layer has a bright portion and a dark portion extending from one surface to the other surface, and in the thickness direction of the cholesteric liquid crystal layer, a region where an inclination angle of the dark portion with respect to the one surface differs from the tilt angle of the liquid crystal compound is present.

[6]

The liquid crystal diffraction element according to any one of [1] to [5], comprising at least two cholesteric liquid crystal layers, in which the at least two cholesteric liquid crystal layers each include a bright portion and a dark portion that extend from one surface to the other surface in a cross-sectional image obtained by observing, with a scanning electron microscope, a cross section cut along the one direction and a thickness direction of the cholesteric liquid crystal layer, and inclination angles of the dark portions included in the at least two cholesteric liquid crystal layers are different from each other.

[7]

A liquid crystal diffraction element comprising: a cholesteric liquid crystal layer, in which the cholesteric liquid crystal layer has a liquid crystal alignment pattern in which a direction of an optical axis derived from the liquid crystal compound changes while continuously rotating along at least one direction in-plane, and the cholesteric liquid crystal layer has a region where, in a case where retardation is measured from a normal direction of a main surface of the cholesteric liquid crystal layer and from a direction inclined with respect to a normal line, a direction in which the retardation is minimum is inclined with respect to the normal direction, and a region where the direction in which the retardation is minimum differs in-plane.

[8]

The liquid crystal diffraction element according to [7], in which, in a case where a length over which the direction of the optical axis derived from the liquid crystal compound rotates by 180° in-plane is defined as one period, the cholesteric liquid crystal layer has a region where the length of the one period in the liquid crystal alignment pattern differs in-plane.

[9]

The liquid crystal diffraction element according to [8], in which the length of the one period in the liquid crystal alignment pattern gradually changes along the one direction, and an angle, from the normal direction of the main surface of the cholesteric liquid crystal layer, of the direction in which the retardation of the cholesteric liquid crystal layer is minimum gradually changes along the one direction.

[10]

The liquid crystal diffraction element according to [8] or [9], in which, in the liquid crystal alignment pattern, as the length of the one period decreases, an angle, from the normal direction of the main surface of the cholesteric liquid crystal layer, of the direction in which the retardation of the cholesteric liquid crystal layer is minimum increases.

[11]

The liquid crystal diffraction element according to any one of [8] to [10], in which the cholesteric liquid crystal layer has a bright portion and a dark portion extending from one surface to the other surface in a cross-sectional image obtained by observing, with a scanning electron microscope, a cross section cut along the one direction and a thickness direction of the cholesteric liquid crystal layer, and in the thickness direction of the cholesteric liquid crystal layer, a region where an inclination angle of the dark portion with respect to the one surface differs from an angle between the direction in which the retardation of the cholesteric liquid crystal layer is minimum and the normal direction of the main surface of the cholesteric liquid crystal layer is present.

[12]

The liquid crystal diffraction element according to [11], further comprising at least two cholesteric liquid crystal layers, in which the at least two cholesteric liquid crystal layers each include a bright portion and a dark portion that extend from one surface to the other surface in a cross-sectional image obtained by observing, with a scanning electron microscope, a cross section cut in the thickness direction along the one direction, and inclination angles, with respect to the one surface, of the dark portions included in each of the at least two cholesteric liquid crystal layers are different from each other.

[13]

An optical device comprising: the liquid crystal diffraction element according to any one of [1] to [12]; and a light source that emits light to be incident on the liquid crystal diffraction element.

[14]

An optical device comprising: the liquid crystal diffraction element according to any one of [1] to [6]; and a light source that emits light to be incident on the liquid crystal diffraction element, in which, in a case where an angle of light incident on the liquid crystal diffraction element from the light source is defined as θin, an emission angle of first-order light reflected from the liquid crystal diffraction element is defined as Om, and a refractive index of the cholesteric liquid crystal layer is defined as nG, a tilt angle θP [°] of the liquid crystal compound satisfies the following expressions (A1) to (A3).

[15]

An optical device comprising: the liquid crystal diffraction element according to any one of [7] to [12]; and a light source that emits light to be incident on the liquid crystal diffraction element, in which, in a case where an angle of light incident on the liquid crystal diffraction element from the light source is θin, an emission angle of first-order light emitted from the liquid crystal diffraction element is θm, and a refractive index of the cholesteric liquid crystal layer is nG, an angle θ2 [°] between a direction DR in which a retardation of the cholesteric liquid crystal layer is minimum and a normal direction of a main surface of the cholesteric liquid crystal layer satisfies the following expressions (B1) to (B3).

According to the present invention, it is possible to provide a liquid crystal diffraction element having excellent diffraction efficiency even in a case where a length of one period in which an orientation of an optical axis derived from a liquid crystal compound changes while continuously rotating along one in-plane direction in a liquid crystal alignment pattern of a reflective type liquid crystal diffraction element is short. In addition, according to the present invention, it is possible to provide an optical device including the liquid crystal diffraction element.

### BRIEF DESCRIPTION OF THE DRAWINGS

FIG. 1 is a plan view conceptually showing a liquid crystal diffraction element according to an embodiment of the present invention.

FIG. 2 is a view conceptually showing a cross section of the liquid crystal diffraction element shown in FIG. 1.

FIG. 3 is a conceptual view for describing the liquid crystal diffraction element according to the embodiment of the present invention.

FIG. 4 is a conceptual view for describing an example of a cholesteric liquid crystal layer.

FIG. 5 is a conceptual view for describing the liquid crystal diffraction element according to the embodiment of the present invention.

FIG. 6 is a conceptual diagram showing an action of the cholesteric liquid crystal layer.

FIG. 7 is a view conceptually showing another example of the liquid crystal diffraction element according to the embodiment of the present invention.

FIG. 8 is a view conceptually showing another example of the liquid crystal diffraction element according to the embodiment of the present invention.

FIG. 9 is a view conceptually showing another example of the liquid crystal diffraction element according to the embodiment of the present invention.

FIG. 10 is a view conceptually showing another example of the liquid crystal diffraction element according to the embodiment of the present invention.

FIG. 11 is a view conceptually showing an example of an optical device according to the embodiment of the present invention.

FIG. 12 is a view for describing the liquid crystal diffraction element according to the embodiment of the present invention.

FIG. 13 is a view conceptually showing another example of the liquid crystal diffraction element according to the embodiment of the present invention.

FIG. 14 is a view conceptually showing another example of the liquid crystal diffraction element according to the embodiment of the present invention.

FIG. 15 is a view conceptually showing an exposure device that manufactures the liquid crystal diffraction element according to the embodiment of the present invention.

FIG. 16 is a view conceptually showing an example of an image display device.

FIG. 17 is a view conceptually showing another example of the image display device.

FIG. 18 is a view conceptually showing another example of the image display device.

FIG. 19 is a view conceptually showing another example of the image display device.

FIG. 20 is a view conceptually showing another example of the image display device.

FIG. 21 is a view conceptually showing another example of the image display device.

FIG. 22 is a view conceptually showing another example of the image display device.

FIG. 23 is a view conceptually showing another example of the image display device.

FIG. 24 is a view conceptually showing an exposure device that manufactures the liquid crystal diffraction element.

FIG. 25 is a view conceptually showing another example of the image display device.

### DESCRIPTION OF THE PREFERRED EMBODIMENTS

Hereinafter, the liquid crystal diffraction element and the optical device according to the embodiments of the present invention will be described in detail based on suitable examples shown in the accompanying drawings.

The description of configuration requirements described below may be made based on typical embodiments of the present invention, but the present invention is not limited to such embodiments.

In addition, all of the drawings described below are conceptual diagrams for explaining the present invention, and the shape, size, thickness, positional relationship, and the like of each member do not necessarily match those of real objects.

In the present specification, numerical ranges represented by “to” include numerical values before and after “to” as lower limit values and upper limit values.

In the present specification, the meaning of “the same” includes a case where an error range is generally allowable in the technical field. In addition, in this specification, the meaning of “all”, “entire”, or “entire surface” includes not only 100% but also a case where an error range is generally allowable in the technical field, for example, 99% or more, 95% or more, or 90% or more.

In addition, for the angle, “orthogonal” or “perpendicular” means a range of 90°±5°, and “parallel” means a range of 0°±5°. Similarly, an angle is meant such that a difference from the exact angle is within 5 degrees unless otherwise specified. The difference in angle is preferably within 4° and more preferably within 3°.

In the present specification, an in-plane retardation Re(λ) (also referred to as “Re”) represents an in-plane retardation at a wavelength λ. In particular, in a case where the measurement wavelength is not described, the wavelength λ is 550 nm.

In the present specification, Re(λ) is a value measured at the wavelength λ in an AxoScan polarized light phase difference analyzer manufactured by Axometrics, Inc. By inputting an average refractive index ((nx+ny+nz)/3) and a thickness (d (μm)) to AxoScan, the following expressions can be calculated.
a slow axis direction(°)
Re(λ)=R0 (λ)

Although R0 (λ) is displayed as a numerical value calculated by AxoScan, it means Re(λ).

In the present invention, the refractive indices nx, ny, and nz are measured using an Abbe refractometer (NAR-4T, manufactured by Atago Co., Ltd.), and a sodium lamp (λ=589 nm) is used as a light source. In addition, the wavelength dependence can be measured using a combination of a multi-wavelength Abbe refractometer (DR-M2, manufactured by Atago Co., Ltd.) and an interference filter.

In addition, the values in Polymer Handbook (John Wiley & Sons, Inc.) and catalogs of various optical films can be used. The values of average refractive index of major optical films are as follows: cellulose acylate (1.48), cycloolefin polymer (1.52), polycarbonate (1.59), polymethyl methacrylate (1.49), and polystyrene (1.59).

### First Embodiment

A liquid crystal diffraction element according to a first embodiment of the present invention includes: a cholesteric liquid crystal layer, in which the cholesteric liquid crystal layer has a liquid crystal alignment pattern in which an orientation of an optical axis derived from a liquid crystal compound changes while continuously rotating in at least one in-plane direction, the cholesteric liquid crystal layer has, on at least one surface of the cholesteric liquid crystal layer, a region where the liquid crystal compound has a tilt angle with respect to the surface of the cholesteric liquid crystal layer, and the cholesteric liquid crystal layer has regions where tilt angles of the liquid crystal compound with respect to the surface of the cholesteric liquid crystal layer are different in-plane.

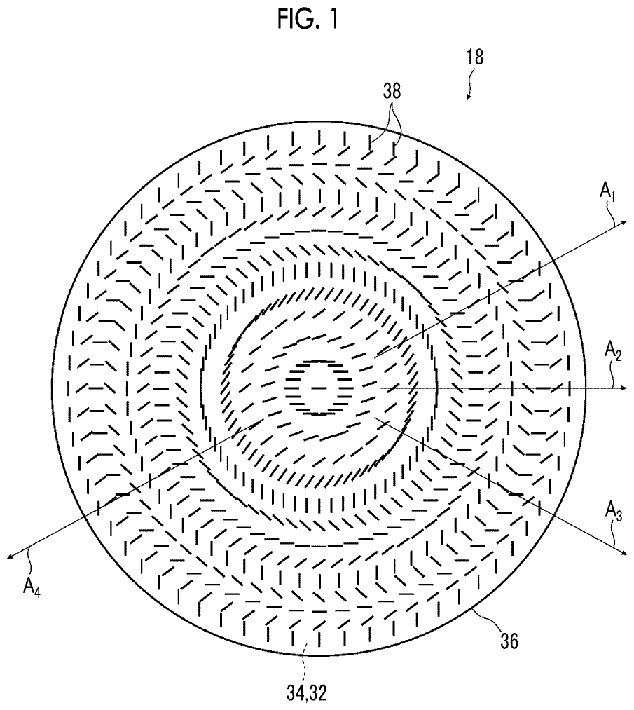

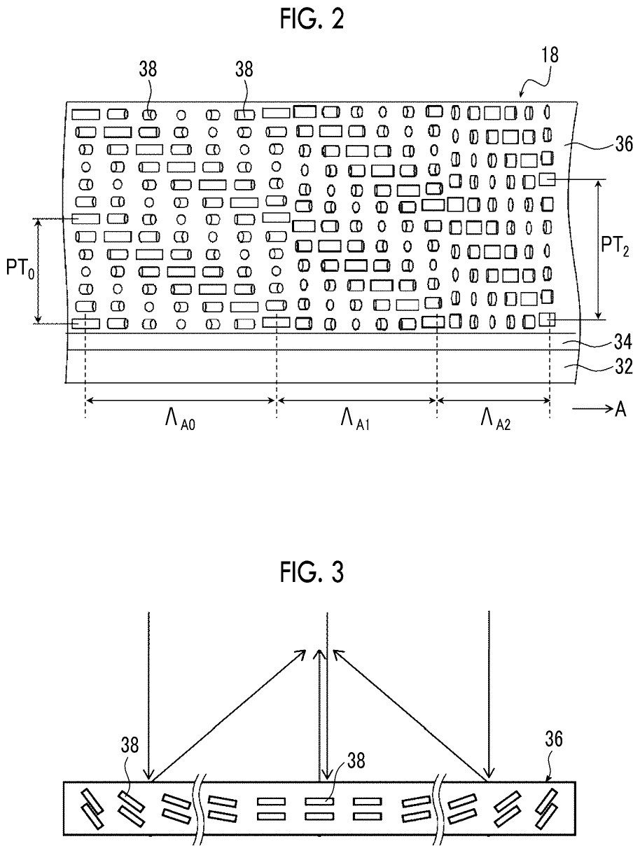

FIGS. 1 and 2 conceptually show an example of the liquid crystal diffraction element according to the present embodiment. FIG. 1 is a plan view, and FIG. 2 is a cross-sectional view in a thickness direction. The liquid crystal diffraction element is used as a reflective type liquid crystal diffraction element (concave mirror).

As shown in FIGS. 1 and 2, a liquid crystal diffraction element 18 includes a substrate 32, an alignment film 34, and a cholesteric liquid crystal layer 36 obtained by fixing a cholesteric liquid crystalline phase. In the liquid crystal diffraction element 18, the cholesteric liquid crystal layer 36 acts as a reflective type liquid crystal diffraction element (concave mirror).

Accordingly, the liquid crystal diffraction element 18 may be composed of only the cholesteric liquid crystal layer 36 by peeling off the substrate 32 and the alignment film 34, may be composed of the alignment film 34 and the cholesteric liquid crystal layer 36 by peeling off the substrate 32, or may be obtained by peeling off the substrate 32 and the alignment film 34 from the cholesteric liquid crystal layer 36 and laminating the cholesteric liquid crystal layer 36 on another base material.

In the liquid crystal diffraction element 18 shown in FIGS. 1 and 2, the cholesteric liquid crystal layer 36 is a liquid crystal layer obtained by aligning and fixing a liquid crystal compound 38 in a liquid crystal alignment pattern using a composition including the liquid crystal compound 38 on the alignment film 34.

Specifically, the cholesteric liquid crystal layer 36 has the liquid crystal alignment pattern in which the orientation of the optical axis derived from the liquid crystal compound 38 changes while continuously rotating in one direction in a radial shape from an inner side toward an outer side. That is, the liquid crystal alignment pattern of the cholesteric liquid crystal layer 36 shown in FIGS. 1 and 2 is a concentric pattern including the one direction in which the orientation of the optical axis derived from the liquid crystal compound 38 changes while continuously rotating in a concentric shape from the inner side toward the outer side.

In FIGS. 1 and 2, for example, a rod-like liquid crystal compound is exemplified as the liquid crystal compound 38, so that the direction of the optical axis matches with a longitudinal direction of the liquid crystal compound 38.

More specifically, in the cholesteric liquid crystal layer 36, the orientation of the optical axis of the liquid crystal compound 38 changes while continuously rotating in a plurality of directions radially outward from the center of the cholesteric liquid crystal layer 36 (that is, the optical axis in a case of functioning as a concave mirror), for example, a direction indicated by an arrow A₁, a direction indicated by an arrow A₂, a direction indicated by an arrow A₃, a direction indicated by an arrow A₄, and so on.

In the cholesteric liquid crystal layer 36, the rotation direction of the optical axis of the liquid crystal compound 38 is the same in all directions (one direction). In the example shown in the drawing, the rotation direction of the optical axis of the liquid crystal compound 38 is counterclockwise, in all the directions including the direction indicated by the arrow A₁, the direction indicated by the arrow A₂, the direction indicated by the arrow A₃, and the direction indicated by the arrow A₄.

That is, in a case where the arrow A₁ and the arrow A₄ are regarded as one straight line, the rotation direction of the optical axis of the liquid crystal compound 38 is reversed at the center of the cholesteric liquid crystal layer 36 on the straight line. As an example, it is assumed that the straight line formed by the arrow A₁ and the arrow A₄ is directed toward the right direction (arrow A₁ direction) in the figure. In this case, the optical axis of the liquid crystal compound 38 initially rotates clockwise from the outer direction of the cholesteric liquid crystal layer 36 toward the center, the rotation direction is reversed at the center of the cholesteric liquid crystal layer 36, and then the optical axis rotates counterclockwise from the center of the cholesteric liquid crystal layer 36 toward the outer direction. In a case where the cholesteric liquid crystal layer 36 functions as a concave mirror, the center of the cholesteric liquid crystal layer 36 corresponds to the optical axis of the concave mirror.

In addition, in FIG. 2, the liquid crystal compound 38 is shown parallel to the surface of the cholesteric liquid crystal layer 36 in order to clarify the configuration of the cholesteric liquid crystal layer 36.

However, in the liquid crystal diffraction element 18 that is the liquid crystal diffraction element according to the present embodiment, the liquid crystal compound 38 has a region having a tilt angle with respect to the surface of the cholesteric liquid crystal layer 36, that is, the main surface on at least one surface of the cholesteric liquid crystal layer 36. The main surface is the maximum surface of a layer (sheet-like material, membrane, or film), and is usually both surfaces in the thickness direction.

In the liquid crystal diffraction element 18 of the example shown in the drawing, as conceptually shown in FIG. 3, in a center region of the concentric circle, the liquid crystal compound 38 is aligned parallel to both surfaces of the cholesteric liquid crystal layer 36. On the other hand, in a region separated from the center of the concentric circle, the liquid crystal compound 38 is in a state where the tilt angle is aligned at an angle with respect to both surfaces of the cholesteric liquid crystal layer 36, that is, in a state where the tilt alignment is performed. In the example shown in the drawing, the liquid crystal compound 38 has a tilt angle such that the liquid crystal compound 38 rises from the outer side toward the inner side with respect to the center of the concentric circle.

The expression “the liquid crystal compound has a tilt angle with respect to the surface of the cholesteric liquid crystal layer” means that the angle of the direction of the optical axis of the liquid crystal compound with respect to the surface of the cholesteric liquid crystal layer is more than 0°.

In addition, as conceptually shown in FIG. 3, in the liquid crystal diffraction element 18 in the example shown in the drawing, as a preferred example, the tilt angle of the liquid crystal compound 38 gradually increases from the inner side toward the outer side of the concentric circle. That is, in the liquid crystal diffraction element 18, the tilt angle of the liquid crystal compound 38 gradually increases from the center toward the outer side of the concentric circle.

As will be described below, the cholesteric liquid crystal layer 36 has a liquid crystal alignment pattern in which the length over which the direction of the optical axis derived from the liquid crystal compound in the liquid crystal alignment pattern rotates by 180° is set as one period, and the one period gradually decreases from the inner side toward the outer side of the concentric circle.

As described above, the tilt angle of the liquid crystal compound 38 in the cholesteric liquid crystal layer 36 gradually increases from the inner side toward the outer side of the concentric circle. That is, in the cholesteric liquid crystal layer 36 of the liquid crystal diffraction element 18, the tilt angle of the liquid crystal compound 38 increases as the one period of the liquid crystal alignment pattern decreases.

In FIG. 3, the liquid crystal compound in a state where the liquid crystal alignment pattern is not provided is shown in order to clearly show the state of the tilt alignment of the liquid crystal compound 38 in the cholesteric liquid crystal layer 36.

Regarding this point, the same can also be applied to FIGS. 7 to 10 described below.

As is well known, the cholesteric liquid crystal layer (liquid crystal layer) having a liquid crystal alignment pattern in which the direction of the optical axis derived from the liquid crystal compound 38 changes while continuously rotating in one direction selectively reflects light having a specific wavelength and acts as a reflective type liquid crystal diffraction element that reflects light in a direction different from specular reflection (mirror surface reflection). Hereinafter, the reflection of light in a direction different from specular reflection is also referred to as diffraction (bending) of the reflected light.

Specifically, in the cholesteric liquid crystal layer 36 having the liquid crystal alignment pattern in which the direction of the optical axis of the liquid crystal compound 38 changes while continuously rotating in one direction, the diffraction direction (refraction direction) of the reflected light with respect to the specular reflection direction depends on the rotation direction of the optical axis of the liquid crystal compound 38. That is, in this liquid crystal alignment pattern, in a case where the rotation direction of the optical axis of the liquid crystal compound 38 toward one direction is opposite, the diffraction direction of the reflected light with respect to the specular reflection direction is opposite to the one direction in which the optical axis rotates.

As is well known, the cholesteric liquid crystalline phase exhibits selective reflectivity (wavelength-selective reflectivity) with respect to any of left or right circularly polarized light at a specific wavelength. Whether or not the reflected light is right circularly polarized light or left circularly polarized light is determined depending on a helically twisted direction (sense) of the cholesteric liquid crystalline phase. Regarding the selective reflection of the circular polarization by the cholesteric liquid crystalline phase, in a case where the helically twisted direction of the cholesteric liquid crystalline phase is right, right circularly polarized light is reflected, and in a case where the helically twisted direction of the cholesteric liquid crystalline phase is left, left circularly polarized light is reflected.

For example, in the liquid crystal diffraction element 18 shown in FIG. 2, in a case where the cholesteric liquid crystal layer 36 has a selective reflection center wavelength in a green wavelength range and selectively reflects right circularly polarized light of green light, the cholesteric liquid crystal layer 36 reflects right circularly polarized light GR of green light and transmits the other light, in which the twisted direction of the helix of the cholesteric liquid crystalline phase is right.

The turning direction of the cholesteric liquid crystalline phase can be adjusted by the kind of the liquid crystal compound forming the cholesteric liquid crystal layer and/or the kind of the chiral agent to be added.

In the cholesteric liquid crystal layer 36 of the liquid crystal diffraction element 18, in the liquid crystal alignment pattern, a length over which the direction of the optical axis rotates by 180° in the one direction in which the direction of the optical axis derived from the liquid crystal compound 38 changes while continuously rotating is set as one period (one period A). That is, in the cholesteric liquid crystal layer 36 that is the liquid crystal diffraction element, the one period is the one period as the diffraction structure.

In the liquid crystal diffraction element 18 of the shown example, in the cholesteric liquid crystal layer 36, the length of the one period gradually decreases from the inner side toward the outer side.

Here, in the liquid crystal layer having the liquid crystal alignment pattern in which the orientation of the optical axis of the liquid crystal compound 38 changes while continuously rotating in the one direction, the diffraction angle increases as the length of the one period decreases. Accordingly, in the cholesteric liquid crystal layer 36 having the concentric liquid crystal alignment pattern, the diffraction angle gradually increases from the center of the concentric circle toward the outer side.

As described above, in the cholesteric liquid crystal layer 36 of the shown example, as the one period of the liquid crystal alignment pattern decreases, the tilt angle of the liquid crystal compound 38 increases.

Accordingly, the cholesteric liquid crystal layer 36 having the concentric liquid crystal alignment pattern in which the liquid crystal alignment pattern in which the optical axis derived from the liquid crystal compound changes while continuously rotating is radially provided can reflect incident light (light beam) in a diverging or converging manner depending on the rotation direction of the optical axis of the liquid crystal compound 38 and the twisted direction of the helix of the cholesteric liquid crystalline phase.

In other words, the liquid crystal diffraction element 18 including the cholesteric liquid crystal layer 36 acts as a concave mirror or a convex mirror that selectively reflects right circularly polarized light in a case where the twisted direction of the helix of the cholesteric liquid crystalline phase is the right direction, and acts as a concave mirror or a convex mirror that selectively reflects left circularly polarized light in a case where the twisted direction of the helix of the cholesteric liquid crystalline phase is the left direction.

In FIGS. 1 and 3, in order to simplify the drawing and to clarify the configuration of the liquid crystal diffraction element 18, the cholesteric liquid crystal layer 36 shows only the liquid crystal compound 38 (liquid crystal compound molecules) on the surface of the alignment film 34. However, as conceptually shown in FIG. 2, the cholesteric liquid crystal layer 36 has a helical structure in which the liquid crystal compound 38 is helically turned and laminated, and has a structure in which the liquid crystal compound 38 helically turned is laminated by one pitch or more, in which a configuration in which the liquid crystal compound 38 is helically rotated once (rotated by 360°) and laminated is set as one pitch (helical pitch) of the helical structure. It is preferable that the cholesteric liquid crystal layer 36 has a structure in which the liquid crystal compound 38 helically turned is laminated by a plurality of pitches.

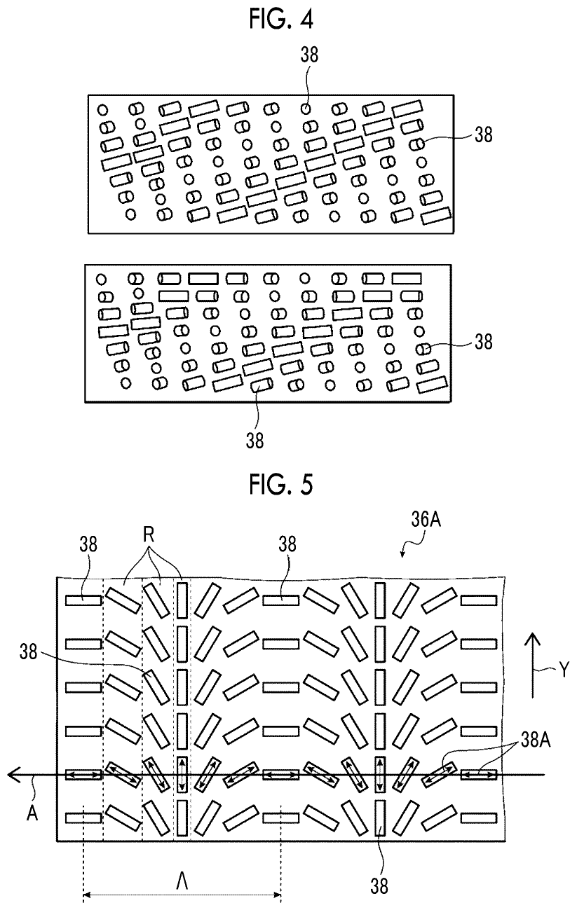

In addition, in the liquid crystal diffraction element 18 of the shown example, the tilt angle of the liquid crystal compound 38 in the cholesteric liquid crystal layer 36 may be the same in the entire region in the thickness direction as shown in the upper part of FIG. 4 or may be different in the thickness direction as shown in the lower part of FIG. 4 at the same position in plane.

The tilt angle (inclined angle) of the liquid crystal compound with respect to the surface of the cholesteric liquid crystal layer can be measured by observing the direction of the optical axis of the liquid crystal compound using a polarizing microscope in a cross section obtained by cutting the cholesteric liquid crystal layer along the thickness direction of the cholesteric liquid crystal layer.

Specifically, the tilt angle of the liquid crystal compound in the inside of the cholesteric liquid crystal layer in the thickness direction, which will be described below, can be measured by cutting the cholesteric liquid crystal layer along the direction in which the optical axis continuously rotates and the thickness direction to prepare a sample and observing the direction of the optical axis of the liquid crystal compound using a polarizing microscope while rotating the cut surface of the obtained sample.

In addition, the tilt angle (inclined angle) of the liquid crystal compound with respect to the surface of the cholesteric liquid crystal layer can be measured by analyzing the surface of the cholesteric liquid crystal layer using second harmonic generation (SHG).

Hereinafter, an action of the cholesteric liquid crystal layer 36 will be described in detail with reference to FIG. 5. FIG. 5 is a plan view conceptually showing a configuration of the cholesteric liquid crystal layer, and a cholesteric liquid crystal layer 36A shown in FIG. 5 has a liquid crystal alignment pattern in which an optical axis 38A derived from the liquid crystal compound 38 changes while continuously rotating in one direction indicated by an arrow A.

Regarding the one direction in which the optical axis changes while continuously rotating, the same optical action effect as that of the liquid crystal alignment pattern shown in FIG. 5 is exhibited even in the concentric liquid crystal alignment pattern shown in FIG. 1.

In the following description, the optical axis 38A derived from the liquid crystal compound 38 will also be referred to as “optical axis 38A of the liquid crystal compound 38” or “optical axis 38A”.

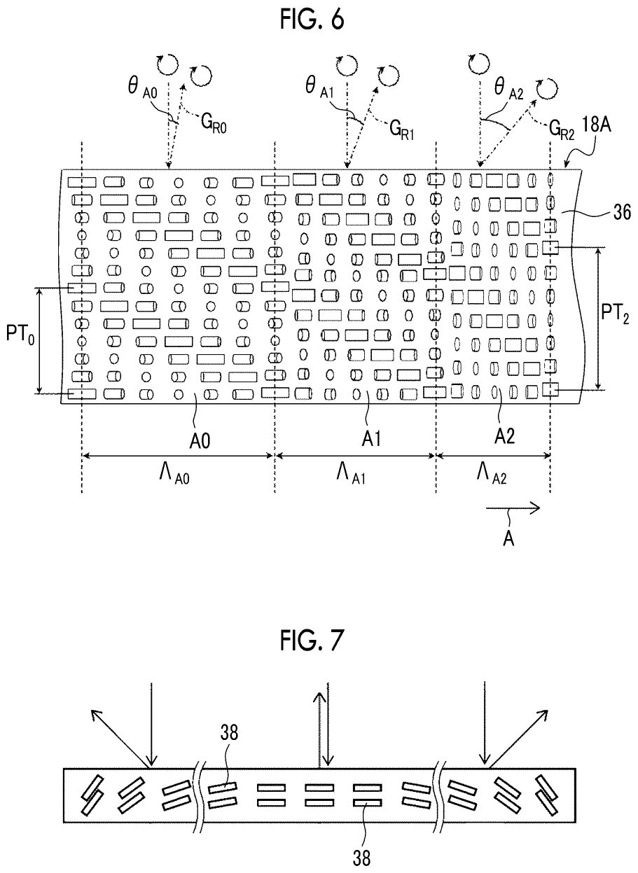

In the cholesteric liquid crystal layer 36A, the liquid crystal compound 38 is two-dimensionally aligned in-plane parallel to the one direction indicated by the arrow A and a Y direction orthogonal to the arrow A direction. In the cholesteric liquid crystal layer 36 shown in FIG. 1, a circumferential direction of the concentric circle in the concentric liquid crystal alignment pattern corresponds to the Y direction in FIG. 5. In addition, in the cholesteric liquid crystal layer 36 shown in FIGS. 2 and 6, a direction orthogonal to the paper surface corresponds to the Y direction in FIG. 5.

In the following description, “one direction indicated by the arrow A” will also be simply referred to as “arrow A direction”.

The cholesteric liquid crystal layer 36A has a liquid crystal alignment pattern in which the orientation of the optical axis 38A derived from the liquid crystal compound 38 changes while continuously rotating in the arrow A direction in-plane of the cholesteric liquid crystal layer 36A.

Specifically, the phrase “the orientation of the optical axis 38A of the liquid crystal compound 38 changes while continuously rotating in the arrow A direction (predetermined one direction)” represents that an angle between the optical axis 38A of the liquid crystal compound 38 arranged along the arrow A direction and the arrow A direction varies depending on positions in the arrow A direction, and the angle between the optical axis 38A and the arrow A direction sequentially changes from θ to θ+180° or θ−180° along the arrow A direction.

Meanwhile, regarding the liquid crystal compound 38 forming the cholesteric liquid crystal layer 36A, liquid crystal compounds 38 in which the optical axis 38A is oriented in the same direction are arranged at regular intervals in the Y direction orthogonal to the arrow A direction, that is, the Y direction orthogonal to the one direction in which the optical axis 38A continuously rotates.

In other words, in the liquid crystal compound 38 forming the cholesteric liquid crystal layer 36, the angles between the orientations of the optical axes 38A and the arrow A direction are the same in the liquid crystal compounds 38 arranged in the Y direction.

In the cholesteric liquid crystal layer 36 shown in FIG. 1, regions where the orientations of the optical axes 38A are the same are formed in an annular shape having the same center, and a concentric liquid crystal alignment pattern is formed.

As described above, in the liquid crystal alignment pattern in which the optical axis 38A continuously rotates in the one direction, the length (distance) over which the optical axis 38A of the liquid crystal compound 38 rotates by 180° is a length ∧ of the one period in the liquid crystal alignment pattern.

That is, in the cholesteric liquid crystal layer 36A shown in FIG. 5, a length (distance) over which the optical axis 38A of the liquid crystal compound 38 rotates by 180° in the arrow A direction in which the orientation of the optical axis 38A changes while continuously rotating in-plane is set as one period ∧ in the liquid crystal alignment pattern. In other words, the one period ∧ in the liquid crystal alignment pattern is defined as a distance from θ to θ+180° of the angle between the optical axis 38A of the liquid crystal compound 38 and the arrow A direction.

That is, a distance between centers of two liquid crystal compounds 38 in the arrow A direction is the one period ∧, the two liquid crystal compounds having the same angle in the arrow A direction. Specifically, as shown in FIG. 5, a distance between centers in the arrow A direction of two liquid crystal compounds 38 in which the arrow A direction matches the direction of the optical axis 38A is the one period ∧.

In the cholesteric liquid crystal layer 36A (cholesteric liquid crystal layer 36), the liquid crystal alignment pattern is repeated in the arrow A direction, that is, the one direction in which the orientation of the optical axis 38A changes while continuously rotating, at the length ∧ of the one period.

As described above, the cholesteric liquid crystal layer 36A having such a liquid crystal alignment pattern is also a reflective type liquid crystal diffraction element, and the length ∧ of the one period is the period (one period) of the diffraction structure.

In the cholesteric liquid crystal layer 36A, the liquid crystal compounds arranged in the Y direction have the same angle between the optical axis 38A and the arrow A direction. A region in which liquid crystal compounds 38 having the same angle between the optical axis 38A and the arrow A direction are arranged in the Y direction will be referred to as a region R.

In the liquid crystal diffraction element 18 having the concentric circular liquid crystal alignment pattern with the liquid crystal alignment pattern in which the optical axis 38A continuously rotates in one direction in a radial shape, regions where the orientations of the optical axes 38A are the same and that are formed in an annular shape where the centers match with each other correspond to the region R in FIG. 5.

In a case where light is incident into the cholesteric liquid crystal layer 36A, light having a specific wavelength is selectively converted (diffracted) and reflected in a direction different from specular reflection.

Hereinafter, the action of the cholesteric liquid crystal layer will be described in more detail with reference to FIG. 6.

In FIG. 6, only the cholesteric liquid crystal layer 36 is shown in order to clearly show the action of the liquid crystal diffraction element 18A. In addition, for the same reason, it is assumed that light is incident into the liquid crystal diffraction element 18A from the normal direction (front). In addition, for description, the cholesteric liquid crystal layer 36 selectively reflects right circularly polarized light GR of green light and allows transmission of the other light.

As described above, the action is also the same in the liquid crystal diffraction element 18 having the concentric circular liquid crystal alignment pattern with the liquid crystal alignment pattern in which the optical axis 38A continuously rotates in the one direction in a radial shape.

In addition, in FIG. 6, the liquid crystal compound 38 is shown in a state where the liquid crystal compound 38 does not have a tilt angle in order to clearly show the alignment state of the liquid crystal compound 38. However, in the liquid crystal diffraction element according to the present embodiment, as described above, the cholesteric liquid crystal layer has a region where the liquid crystal compound has a tilt angle with respect to the surface of the cholesteric liquid crystal layer and further has regions where the tilt angles of the liquid crystal compounds are different from each other in-plane of the cholesteric liquid crystal layer.

In the portion shown in FIG. 6, the cholesteric liquid crystal layer 36 has three regions A0, A1, and A2 from the left side in FIG. 6, and the length of the helical pitch and the length A of the one period are different in each region. Specifically, the helical pitch increases in order of the regions A0, A1, and A2, and the length ∧ of the one period decreases in order of the regions A0, A1, and A2. However, FIG. 6 shows an example of the configuration of the cholesteric liquid crystal layer 36, and the cholesteric liquid crystal layer 36 may have two or four or more regions where the length of the helical pitch and the length ∧ of the one period are different from each other.

In the liquid crystal diffraction element 18A, in a case where the right circularly polarized light G_{R1} of green light is incident into the in-plane region A1 of the cholesteric liquid crystal layer 36, as described above, the light is reflected in a direction tilted by a predetermined angle in the arrow A direction, that is, in the one direction in which the orientation of the optical axis of the liquid crystal compound changes while continuously rotating, with respect to the incidence direction. Similarly, in a case where the right circularly polarized light G_{R2} of green light is incident into the in-plane region A2 of the cholesteric liquid crystal layer 36, the light is reflected in a direction tilted by a predetermined angle in the arrow A direction with respect to the incidence direction. Similarly, in a case where the right circularly polarized light G_{R2} of green light is incident into the in-plane region A0 of the cholesteric liquid crystal layer 36, the light is reflected in a direction tilted by a predetermined angle in the arrow A direction with respect to the incidence direction.

Since the one period ∧_{A2} of the liquid crystal alignment pattern in the region A2 is shorter than the one period ∧_{A1} of the liquid crystal alignment pattern in the region A1, as shown in FIG. 6, the angle of reflected light from the cholesteric liquid crystal layer 36 with respect to the incidence light in the region A2 (angle θ_{A2}) is larger than the angle of reflected light from the cholesteric liquid crystal layer 36 with respect to the incidence light in the region A1 (angle θ_{A1}). In addition, since one period ∧_{A0} of the liquid crystal alignment pattern of the region A0 is longer than the one period ∧_{A1} of the liquid crystal alignment pattern of the region A1, as shown in FIG. 6, a reflection angle θ_{A0} of reflected light of the region A0 is less than the reflection angle θ_{A1} of reflected light of the region A₁ with respect to the incidence light.

As described above, in the cholesteric liquid crystal layer 36A, the angle of diffraction of the right circularly polarized light GR that is reflected light can be adjusted by changing the one period ∧ of the formed liquid crystal alignment pattern. Specifically, as the one period A of the liquid crystal alignment pattern decreases, light transmitted through the liquid crystal compounds 38 adjacent to each other more strongly interferes with each other, so that the transmitted light can be more largely diffracted.

In the liquid crystal diffraction element according to the present embodiment, the one period ∧ of the liquid crystal alignment pattern in the cholesteric liquid crystal layer is not particularly limited. That is, the one period of the liquid crystal alignment pattern may be appropriately set depending on the application of the liquid crystal diffraction element, the optical characteristics required for the liquid crystal diffraction element, such as the focal length, the size of the liquid crystal diffraction element, and the like, to obtain a desired optical characteristic. In addition, in a case where the cholesteric liquid crystal layer has the liquid crystal alignment pattern in which the one period ∧ changes in the in-plane direction as in the example shown in the drawing, the degree of change may be similarly set.

Here, in a case where the one period of the liquid crystal alignment pattern decreases, a decrease in diffraction efficiency described below increases accordingly. That is, as the one period of the liquid crystal alignment pattern decreases, the effect of the present invention in which the liquid crystal compound is tilted is more significantly obtained.

In consideration of this point, the liquid crystal alignment pattern in the cholesteric liquid crystal layer preferably includes a region where the length of the one period ∧ is 100 μm or less, more preferably includes a region where the length of the one period ∧ is 10 μm or less, still more preferably includes a region where the length of the one period ∧ is 2 μm or less, and particularly preferably includes a region where the length of the one period ∧ is 1 μm or less.

The lower limit of the one period ∧ of the liquid crystal alignment pattern in the cholesteric liquid crystal layer is not particularly limited. However, in consideration of the accuracy of the liquid crystal alignment pattern, the diffraction efficiency, and the like, the one period ∧ is preferably 0.1 μm or more.

A preferred one period of the liquid crystal alignment pattern varies depending on the application of the liquid crystal diffraction element, and the like. For example, in a case of the liquid crystal diffraction element used to allow the reflected light to be emitted in a wide angle as shown in FIGS. 7 and 9, the effect of tilting the liquid crystal compound can be suitably obtained even in a case where the one period ∧ is several tens of μm or more.

In addition, in the cholesteric liquid crystal layer 36A, by reversing the rotation direction of the optical axis 38A of the liquid crystal compound 38 rotating in the arrow A direction, the direction in which the reflected light is diffracted with respect to specular reflection can be reversed.

Furthermore, in the cholesteric liquid crystal layer 36A, circularly polarized light to be reflected can be selected depending on the twisted direction of the helix of the cholesteric liquid crystalline phase.

Regarding the above-described point, the same can be applied to the cholesteric liquid crystal layer 36 (liquid crystal diffraction element 18) having the concentric liquid crystal alignment pattern.

Accordingly, the liquid crystal diffraction element 18 including the cholesteric liquid crystal layer 36 having the concentric liquid crystal alignment pattern acts as a concave mirror that collects the reflected light or a convex mirror that emits the reflected light in a divergent manner depending on the rotation direction of the optical axis 38A and the twisted direction of the helix of the cholesteric liquid crystalline phase.

As described above, in a case where the liquid crystal diffraction element 18 (liquid crystal lens) is used in a head-mounted display, it is necessary to shorten the focal length of the liquid crystal diffraction element 18 in order to reduce the thickness and size of the optical system.

In addition, as described above, in the liquid crystal diffraction element having the liquid crystal alignment pattern in which the optical axis 38A of the liquid crystal compound 38 continuously rotates in the one direction, as the one period ∧ over which the optical axis 38A rotates by 180° decreases, the diffraction angle of light increases.

However, in the liquid crystal diffraction element having such a liquid crystal alignment pattern, in a case where the one period ∧ decreases, there is a problem in that the diffraction efficiency decreases, for example, the amount of zero-order light which is not diffracted by the liquid crystal diffraction element increases. In particular, in a case where the one period ∧ decreases to the level of 1 μm, the decrease in diffraction efficiency is large. The present inventors have conducted intensive studies to solve the problem.

As a result, it was found that, in the cholesteric liquid crystal layer, by setting the liquid crystal compound constituting the cholesteric liquid crystal layer of the liquid crystal diffraction element to a state where the liquid crystal compound has an angle with respect to the surface of the cholesteric liquid crystal layer, that is, a state where the liquid crystal compound 38 has a tilt angle with respect to the surface of the cholesteric liquid crystal layer 36, the decrease in the diffraction efficiency can be suppressed even in a case where the one period in the liquid crystal diffraction element decreases.

The first embodiment of the present invention has been made based on the findings, in which the cholesteric liquid crystal layer that mainly acts as a diffraction element in the liquid crystal diffraction element includes a region where the liquid crystal compound has a tilt angle with respect to the surface of the cholesteric liquid crystal layer on at least one surface of the cholesteric liquid crystal layer. Further, the cholesteric liquid crystal layer includes regions where the tilt angles of the liquid crystal compound with respect to the surface of the cholesteric liquid crystal layer are different in-plane from each other.

In a case where the liquid crystal diffraction element according to the present embodiment has such a configuration, even in a case where the one period ∧ of the liquid crystal alignment pattern in the cholesteric liquid crystal layer 36 is as short as 1 μm or less, an excellent diffraction efficiency can be obtained.

Therefore, in a case where the liquid crystal diffraction element according to the present embodiment is used as, for example, a concave mirror having a short focal length, light can be collected with a high light collection efficiency.

In the liquid crystal diffraction element 18 in the example shown in the drawing, the one period ∧ in the liquid crystal alignment pattern of the cholesteric liquid crystal layer 36 gradually decreases from the inner side toward the outer side of the concentric circle.

Accordingly, in the cholesteric liquid crystal layer 36 of the liquid crystal diffraction element 18, the tilt angle of the liquid crystal compound 38 gradually increases from the inner side toward the outer side of the concentric circle. Specifically, as conceptually shown in FIG. 3, in the cholesteric liquid crystal layer 36, the liquid crystal compound 38 is aligned parallel (0°) to both surfaces of the cholesteric liquid crystal layer 36 in a center region of the concentric circle, the liquid crystal compound 38 is in a state where the liquid crystal compound 38 has a tilt angle from a region slightly away from the center of the concentric circle, and the tilt angle of the liquid crystal compound 38 gradually increases from the inner side toward the outer side of the concentric circle.

As described above, the tilt angle of the liquid crystal compound 38 may be uniform in the entire region in the thickness direction or may vary in the thickness direction at the same position in-plane of the cholesteric liquid crystal layer 36.

That is, in the liquid crystal diffraction element according to the present embodiment, the cholesteric liquid crystal layer may include a region where the liquid crystal compound 38 does not have a tilt angle, that is, a region where the liquid crystal compound is not tilted and aligned in at least a part of a plane.

In addition, the liquid crystal diffraction element according to the present embodiment may have a configuration where the liquid crystal compound 38 has a tilt angle in the entire region in-plane of the cholesteric liquid crystal layer, that is, a configuration where the liquid crystal compound 38 is tilted and aligned in the entire region in-plane of the cholesteric liquid crystal layer.

In the gradual change in the tilt angle of the liquid crystal compound 38, the change in the tilt angle may be a continuous change, a stepwise change having a region where the tilt angle is the same, or a mixture of a region where the tilt angle continuously changes and a region where the tilt angle changes stepwise.

The same applies to the other configuration in which the tilt angle of the liquid crystal compound 38 gradually changes.

In addition, a direction of tilt (inclination) of the liquid crystal compound in the cholesteric liquid crystal layer is preferably a direction in which the liquid crystal compound rises toward a diffraction direction of reflected light with respect to specular reflection by the liquid crystal diffraction element.

That is, in a case where the liquid crystal diffraction element 18 (cholesteric liquid crystal layer 36) in the example shown in the drawing acts as a concave mirror that collects light, as shown in FIG. 3, the liquid crystal compound 38 is tilted to rise toward the center, that is, the light collection direction. On the contrary, in a case where the liquid crystal diffraction element acts as a convex mirror that diverges reflected light, as conceptually shown in FIG. 7, the liquid crystal compound 38 is tilted to rise from the inner side to the outer side, that is, in a direction in which light is diverged, in a manner opposite to that in FIG. 3.

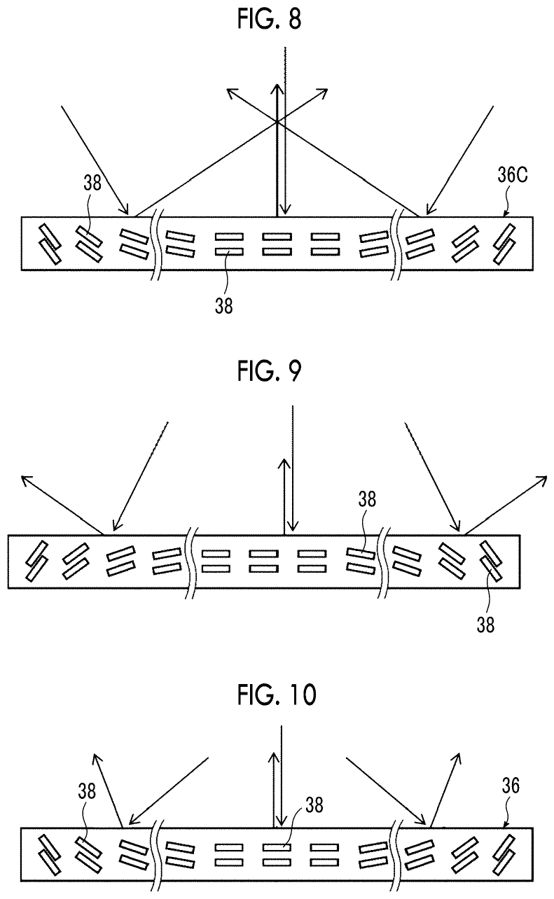

The liquid crystal diffraction element according to the present embodiment can also be used as a liquid crystal diffraction element that reflects and collects light that is incident at a wide angle, as conceptually shown in FIG. 8 using a cholesteric liquid crystal layer 36C as an example.

In such an application, the diffraction efficiency decreases due to oblique incidence of light into the liquid crystal diffraction element. In this case, the decrease in diffraction efficiency can be suppressed by allowing the liquid crystal compound to have a tilt angle with respect to the surface of the cholesteric liquid crystal layer. Here, as the incidence angle of light into the liquid crystal diffraction element (cholesteric liquid crystal layer) increases, the diffraction efficiency of the liquid crystal diffraction element decreases. Accordingly, in the liquid crystal diffraction element that reflects and collects light that is incident at a wide angle, it is preferable that the tilt angle of the liquid crystal compound increases as the incidence angle of light into the liquid crystal diffraction element increases. Regarding this point, the same applies to an aspect in which divergent light is incident as shown below.

The incidence angle is an angle with respect to a normal line of the liquid crystal diffraction element, that is, a polar angle. In addition, the normal line is a line in a direction orthogonal to the surface of the sheet-like material.

In addition, the liquid crystal diffraction element according to the present embodiment can also be used for divergent light. For example, as shown in FIG. 9, divergent light may be incident into the liquid crystal diffraction element (only the cholesteric liquid crystal layer is shown in FIG. 9), and the liquid crystal diffraction element may further cause the reflected light to be divergent. In a case where the liquid crystal diffraction element is used as a convex mirror, the liquid crystal compound is tilted to stand up from the inner side toward the outer side, that is, in a direction in which light is emitted, as described above.

Alternatively, as conceptually shown in FIG. 10, by causing the liquid crystal diffraction element (described above) that acts as a concave mirror to collect the reflected light by causing the divergent light to be incident into the liquid crystal diffraction element, the divergence can be weakened. Further, the light to be collected may be incident into the liquid crystal diffraction element that acts as a concave mirror to strengthen the collection as shown in FIG. 8. Further, although not shown, the light to be collected may be incident into the liquid crystal diffraction element that acts as a convex mirror to weaken the collection.

As described above, in the liquid crystal diffraction element 18 of the shown example, in the cholesteric liquid crystal layer 36, the one period ∧ in the liquid crystal alignment pattern gradually decreases from the inner side toward the outer side of the concentric circle. In the liquid crystal diffraction element 18, as a preferable aspect, the tilt angle of the liquid crystal compound 38 in the cholesteric liquid crystal layer 36 gradually increases from the inner side toward the outer side.

That is, in the cholesteric liquid crystal layer of the liquid crystal diffraction element 18 of the shown example, the tilt angle of the liquid crystal compound 38 increases as the one period ∧ in the liquid crystal alignment pattern decreases. In other words, in the cholesteric liquid crystal layer of the liquid crystal diffraction element 18 of the shown example, the tilt angle of the liquid crystal compound 38 increases in conjunction with the decrease in the one period ∧ in the liquid crystal alignment pattern.

However, the liquid crystal diffraction element according to the present embodiment is not limited to the above-described aspect.

That is, in the liquid crystal diffraction element according to the present embodiment, the tilt angle of the liquid crystal compound in the plane of the cholesteric liquid crystal layer may be constant, the tilt angle may decrease in conjunction with the decrease in the one period A in the liquid crystal alignment pattern, or the tilt angle may not change in conjunction with the change in the one period ∧ in the liquid crystal alignment pattern.

In addition, in at least a part or the entire liquid crystal diffraction element, an aspect in which the tilt angle of the liquid crystal compound in the cholesteric liquid crystal layer gradually changes as the one period ∧ in the liquid crystal alignment pattern gradually changes in the one direction in which the optical axis changes while continuously rotating may be adopted.

Here, in the liquid crystal diffraction element (cholesteric liquid crystal layer), the diffraction efficiency decreases as the one period ∧ in the liquid crystal alignment pattern decreases. In consideration of this point, in at least a part (more preferably, the entire part) of the cholesteric liquid crystal layer, it is preferable that the tilt angle of the liquid crystal compound increases as the one period ∧ in the liquid crystal alignment pattern decreases.

In the liquid crystal diffraction element 18 of the shown example, as a preferable aspect, the cholesteric liquid crystal layer 36 acts as a concave mirror, and the one period ∧ in the liquid crystal alignment pattern gradually decreases from the inner side toward the outer side. That is, the cholesteric liquid crystal layer 36 of the shown example has regions where the length of the one period ∧ varies in-plane.

However, the liquid crystal diffraction element according to the present embodiment is not limited to this configuration, and an aspect in which the one period ∧ in the liquid crystal alignment pattern of the cholesteric liquid crystal layer is uniform over the entire surface and the tilt angle of the liquid crystal compound with respect to the surface of the cholesteric liquid crystal layer varies in-plane in the regions may be adopted.

In the liquid crystal diffraction element 18 of the present embodiment, the tilt angle of the liquid crystal compound 38 in the cholesteric liquid crystal layer 36 is not limited as long as there is a region where the liquid crystal compound 38 has a tilt angle with respect to the surface of the cholesteric liquid crystal layer 36 on the surface of the cholesteric liquid crystal layer 36. That is, the tilt angle of the liquid crystal compound 38 may be appropriately set according to the optical characteristics required for the liquid crystal diffraction element 18, the size of the liquid crystal diffraction element 18, the liquid crystal alignment pattern of the cholesteric liquid crystal layer, the incidence angle of light into the liquid crystal diffraction element, and the like.

In the region where the liquid crystal compound 38 has a tilt angle, that is, in the region where the angle between the liquid crystal compound 38 and the surface of the cholesteric liquid crystal layer 36 is more than 0°, the tilt angle of the liquid crystal compound 38 is preferably 5° to 85°, more preferably 10° to 80°, and still more preferably 15° to 70°.

It is preferable that the tilt angle of the liquid crystal compound 38 in the cholesteric liquid crystal layer 36 is 5° or more from the viewpoint that, even in a case where the one period ∧ of the liquid crystal alignment pattern is short, an excellent diffraction efficiency can be obtained, and even in a case where the incidence angle of light into the liquid crystal diffraction element is large, an excellent diffraction efficiency can be obtained.

In addition, it is preferable that the tilt angle of the liquid crystal compound 38 in the cholesteric liquid crystal layer 36 is 85° or less from the viewpoint of alignment stability and the like.

In addition, in the liquid crystal diffraction element 18 of the present embodiment, the cholesteric liquid crystal layer 36 has regions where the tilt angle of the liquid crystal compound 38 varies in the plane.

In the cholesteric liquid crystal layer 36, the difference in the tilt angle of the liquid crystal compound 38 is not limited. That is, the difference in the tilt angle of the liquid crystal compound 38 in the cholesteric liquid crystal layer 36 may be appropriately set according to the optical characteristics required for the liquid crystal diffraction element 18, the size of the liquid crystal diffraction element 18, the liquid crystal alignment pattern of the cholesteric liquid crystal layer, the incidence angle of light into the liquid crystal diffraction element, and the like.

The difference in the tilt angle of the liquid crystal compound 38 in the cholesteric liquid crystal layer 36 is preferably 5° to 85°, more preferably 10° to 80°, and still more preferably 15° to 70°.

It is preferable that the difference in the tilt angle of the liquid crystal compound 38 in the cholesteric liquid crystal layer 36 is 5° or more from the viewpoint that, even in a case where the one period ∧ of the liquid crystal alignment pattern is short, an excellent diffraction efficiency can be obtained, and even in a case where the incidence angle of light into the liquid crystal diffraction element is large, an excellent diffraction efficiency can be obtained.

In addition, it is preferable that the difference in the tilt angle of the liquid crystal compound 38 in the cholesteric liquid crystal layer 36 is 85° or less from the viewpoint of alignment stability in the plane and the like.

In this case, the difference in tilt angle of the liquid crystal compound 38 also includes a liquid crystal compound 38 having a minimum value of the tilt angle of 0°, that is, having no tilt angle.

In the present embodiment, specifically, in a case where the liquid crystal compound is a rod-like liquid crystal compound, the tilt angle of the liquid crystal compound is an angle on an acute angle side formed between one surface of the cholesteric liquid crystal layer and the longitudinal direction (optical axis (slow axis)) of the rod-like liquid crystal compound.

In addition, in a case where the liquid crystal compound is a disk-like liquid crystal compound, the tilt angle of the liquid crystal compound is an angle on an acute angle side formed between one surface of the cholesteric liquid crystal layer and a disk plane of the disk-like liquid crystal compound.

In the definition, the acute angle also includes a right angle.

Here, in the liquid crystal diffraction element of the present embodiment, it is preferable that the tilt angle of the liquid crystal compound 38 and the traveling direction of light in the cholesteric liquid crystal layer 36 are close to each other.

That is, in the liquid crystal diffraction element of the present embodiment, it is preferable that the tilt angle of the liquid crystal compound 38 and the angle between the traveling direction of light in the cholesteric liquid crystal layer 36 and the normal direction of the main surface of the cholesteric liquid crystal layer 36 are close to each other.

A relationship between the tilt angle of the liquid crystal compound 38 and the traveling direction of light in the cholesteric liquid crystal layer 36 will be described with reference to the drawings.

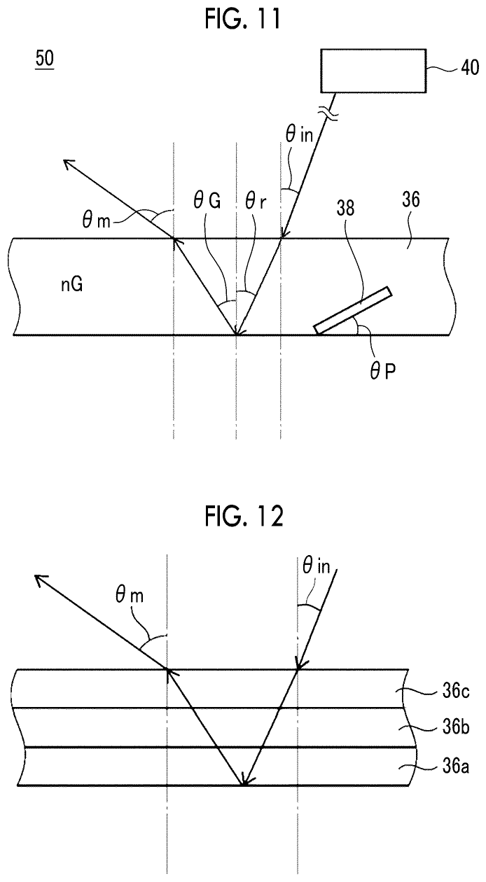

FIG. 11 is a diagram conceptually showing an example of the optical device of the present embodiment including the liquid crystal diffraction element and the light source of the present embodiment. An optical device 50 shown in FIG. 11 includes the cholesteric liquid crystal layer 36 constituting the liquid crystal diffraction element of the present embodiment and a light source 40. In addition, a one-dot chain line in FIG. 11 is a normal line of the cholesteric liquid crystal layer 36.

In the optical device 50, as conceptually shown in FIG. 11, in a case where an angle of incidence of incident light incident into the cholesteric liquid crystal layer 36 (liquid crystal diffraction element) from the light source 40 is denoted by θin, a refractive index of the cholesteric liquid crystal layer 36 is denoted by nG, and an emission angle of first-order light reflected by the cholesteric liquid crystal layer 36 (liquid crystal diffraction element) is denoted by θm, it is preferable that the tilt angle θP [°] of the liquid crystal compound satisfies Expressions (A1) to (A3).

$$θ P [ ° ] = ( θ G [ ° ] - θ r [ ° ] ) / 2 \pm 15 [ ° ] \qquad ( A1 )$$

$$sin θ G = sin θ m / nG \qquad ( A2 )$$

$$sin θ r = sin θ in / nG \qquad ( A3 )$$

Expression (A1) can be rewritten as Expression (A4).

$$( θ G [ ° ] - θ r [ ° ] ) / 2 - 15 ° \leq θ P [ ° ] \leq ( θ G [ ° ] - θ r [ ° ] ) / 2 + 15 ° \qquad ( A4 )$$

With such a configuration, even in a case where the one period ∧ of the liquid crystal alignment pattern in the cholesteric liquid crystal layer 36 is short, a liquid crystal diffraction element having excellent diffraction efficiency can be obtained. In particular, in a case where the diffraction angle is large, from the viewpoint of obtaining a liquid crystal diffraction element having excellent diffraction efficiency and excellent polarization properties (high circular polarization degree), it is preferable.

As will be described below, the liquid crystal diffraction element according to the present embodiment may include a plurality of cholesteric liquid crystal layers. In this case, the refractive index nG of the cholesteric liquid crystal layer is an average refractive index of the plurality of cholesteric liquid crystal layers. In addition, the tilt angle θP [°] is an average tilt angle of a plurality of cholesteric liquid crystal layers in which the thickness of each layer is taken into consideration at a position where light is emitted from the liquid crystal diffraction element 18 (cholesteric liquid crystal layer 36) into the air.

For example, as conceptually shown in FIG. 12, in a case where the liquid crystal diffraction element includes cholesteric liquid crystal layers 36a, 36b, and 36c, the refractive index nG of the cholesteric liquid crystal layer is an average refractive index of the refractive index of the cholesteric liquid crystal layer 36a, the refractive index of the cholesteric liquid crystal layer 36b, and the refractive index of the cholesteric liquid crystal layer 36c. Using the refractive index nG, θr [°] is calculated from Expression (A2), and θG [°] is calculated from Expression (A3).

In addition, in the tilt angle θP, an average tilt angle θP [°] of the tilt angles of the cholesteric liquid crystal layers in which the thickness of each cholesteric liquid crystal layer is taken into consideration on a normal line (one-dot chain line) at a position where light is emitted from the liquid crystal diffraction element 18 (cholesteric liquid crystal layer 36) into the air, that is, the light emission position shown in FIG. 12 may satisfy Expression (A1).

Specifically, in a case where a thickness of the cholesteric liquid crystal layer 36a is denoted by dA, a tilt angle of the liquid crystal compound at the light emission position (one-dot chain line in FIG. 12) of the cholesteric liquid crystal layer 36a is denoted by 0A,
a thickness of the cholesteric liquid crystal layer 36b is denoted by dB, a tilt angle of the liquid crystal compound at the light emission position (same as above) of the cholesteric liquid crystal layer 36b is denoted by OB,
a thickness of the cholesteric liquid crystal layer 36c is denoted by dC, and a tilt angle of the liquid crystal compound at the light emission position (same as above) of the cholesteric liquid crystal layer 36c is denoted by OC, OP is calculated from Expression (A5).

$$θ P [ ° ] = ( θ A \times dA + θ B \times dB + θ C \times dC ) / ( dA + dB + dC ) [ ° ] \qquad ( A5 )$$

θP [°] calculated by Expression (A5) may satisfy Expression (A1).

The action of the liquid crystal diffraction element 18A shown in FIG. 6 will be described in more detail.

In the reflection of light from the cholesteric liquid crystal layer, a so-called blue shift (short-wavelength shift) in which the wavelength of light to be selectively reflected shifts to a short wavelength side occurs depending on angles of incidence light. Therefore, in the cholesteric liquid crystal layer that has a liquid crystal alignment pattern in which a direction of an optical axis derived from a liquid crystal compound changes while continuously rotating in at least one in-plane direction, there is a problem in that the amount of light reflected decreases due to influence of blue shift (short-wavelength shift) as the reflection angle increases. Therefore, in a case where the patterned cholesteric liquid crystal layer has regions having different lengths of the one periods over which the direction of the optical axis of the liquid crystal compound rotates by 180° in-plane, the reflection angle varies depending on light incidence positions. Therefore, there is a difference in the amount of light reflected depending on in-plane incidence positions. That is, a region where reflected light is darkened occurs depending on the in-plane incidence position.

On the other hand, the liquid crystal diffraction element 18A shown in the drawing has regions where the helical pitches of the cholesteric liquid crystal layer are different in-plane. In the example shown in FIG. 6, in the patterned cholesteric liquid crystal layer 36, a length PL_{A2} of the pitch of the helical structure in the region A2 is more than a length PL_{A1} of the pitch of the helical structure in the region A1, and a length PL_{A0} of the pitch of the helical structure in the region A0 is shorter than the length PL_{A1} of the pitch of the helical structure in the region A1.

As a result, the influence of blue shift in which the wavelength of light to be selectively reflected shifts to a short wavelength side can be reduced, and a decrease in the amount of reflected light in the region where the reflection angle of reflected light is large can be suppressed. Specifically, by increasing the length of the pitch of the helical structure such that the selective reflection wavelength during blue shift is the same as the wavelength of light to be incident, the reflection efficiency at the wavelength of light to be incident can be increased. Accordingly, the generation of a region where the brightness of light reflected is low depending on in-plane incidence positions can be suppressed.

In the example shown in FIG. 6, the reflection angle θ_{A1} of reflected light in the region A1 is larger than the reflection angle θ_{A0} of reflected light in the region A0. That is, the length ∧_{A1} of the one period in the region A1 is shorter than the length ∧_{A0} of the one period in the region A0. Therefore, the helical pitch PL_{A1} in the region A1 is set to be longer than the helical pitch PL_{A0} in the region A0. In addition, the helical pitch PL_{A2} in the region A2 where the reflection angle θ_{A2} of reflected light is the largest, that is, the length ∧_{A2} of the one period is the shortest is set to be longer than the helical pitch in the region A0 and the helical pitch in the region A1. As a result, the decrease in the amount of reflected light of light reflected in the regions A1 and A2 can be suppressed, and the amount of reflected light can be made uniform regardless of the in-plane incidence position.

As described above, in the liquid crystal diffraction element 18A, in a region where the reflection angle of the cholesteric liquid crystal layer is large, incidence light is reflected in a region where the pitch of the helical structure is long. On the other hand, in a region where the reflection angle of the cholesteric liquid crystal layer is small, incidence light is reflected in a region where the pitch of the helical structure is short. That is, in the liquid crystal diffraction element 18A, by setting the length of the pitch of the helical structure in-plane according to the magnitude of the reflection angle of the cholesteric liquid crystal layer, reflected light with respect to incidence light can be brightened. Therefore, in the liquid crystal diffraction element 18A, the reflection angle dependence of the amount of reflected light in-plane can be reduced.

In the reflective type liquid crystal diffraction element, as described above, the shorter the one period ∧ of the liquid crystal alignment pattern, the larger the reflection angle. Therefore, the length PL of the pitch of the helical structure is set to be longer in a region where the one period ∧ of the liquid crystal alignment pattern is shorter, which makes it possible to brighten reflected light. Therefore, in the reflective type liquid crystal diffraction element, in regions where the lengths of the one periods of the liquid crystal alignment pattern are different, it is preferable that the length of the pitch of the helical structure decreases as the length of the one period increases.

The liquid crystal diffraction element according to the present embodiment is not limited to the aspect shown in FIG. 6. In the liquid crystal diffraction element, in regions where the lengths of the one periods of the liquid crystal alignment pattern are different, the length of the one period and the length of the pitch of the helical structure may be proportional to each other. In the reflective type liquid crystal diffraction element, the length of the pitch of the helical structure may be appropriately set to be in a preferred range according to the one period ∧ of the liquid crystal alignment pattern in-plane.

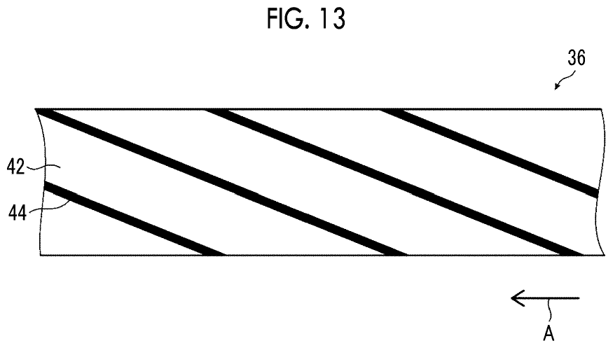

FIG. 13 conceptually shows an image obtained by observing a cross section of the cholesteric liquid crystal layer 36 shown in FIG. 2, which is cut along a direction in which the optical axis continuously rotates and a thickness direction, with a scanning electron microscope (SEM). The cholesteric liquid crystal layer having the above-described liquid crystal alignment pattern has a bright portion 42 and a dark portion 44 extending from one surface to another surface in an image (hereinafter, also referred to as a “cross-sectional SEM image” for convenience) obtained by observing a cross section cut along a direction in which the optical axis continuously rotates and a thickness direction of the cholesteric liquid crystal layer with an SEM.

The bright portions 42 and the dark portions 44 in the cross-sectional SEM image are observed due to the liquid crystal phase having the liquid crystal alignment pattern.

As shown in the drawing, in the cross-sectional SEM image of the cholesteric liquid crystal layer 36, a stripe pattern in which the bright portions 42 and the dark portions 44 are alternately arranged in an arrangement direction that is tilted at a predetermined angle with respect to the main surface is observed.

An interval between the bright portions 42 and the dark portions 44, that is, a surface pitch P basically depends on a helical pitch of the cholesteric liquid crystalline phase, that is, a length of one pitch of a helical structure in which the liquid crystal compound is helically rotated once (rotated by 360°).

A wavelength range of light that is selectively reflected by the cholesteric liquid crystal layer correlates to the surface pitch P that is the interval between the bright portions 42 and the dark portions 44. That is, in a case where the surface pitch P is long, the helical pitch is long. Therefore, the wavelength range of light that is selectively reflected by the cholesteric liquid crystal layer is long. On the contrary, in a case where the surface pitch P is short, the helical pitch is short. Therefore, the wavelength range of light that is selectively reflected by the cholesteric liquid crystal layer is short.

Here, in the cholesteric liquid crystal layer, basically, two repetitions of the bright portion 42 and the dark portion 44 correspond to the helical pitch. Accordingly, in the cross-sectional SEM image, an interval between the bright portions 42 or the dark portions 44 adjacent to each other in a normal direction (orthogonal direction) of a line formed by the bright portion 42 or the dark portion 44 corresponds to ½ pitch of the surface pitch P.

That is, the surface pitch P may be measured by setting the interval between the bright portions 42 or between the dark portions 44 in the normal direction with respect to the lines as a ½ pitch.

In the cholesteric liquid crystal layer having the dark portion (bright portion) that is tilted with respect to the surface of the cholesteric liquid crystal layer, such as the cholesteric liquid crystal layer 36 shown in FIG. 13, a tilt angle of the dark portion with respect to the surface and a tilt angle of the liquid crystal compound do not necessarily match each other. Since the tilt angle of the bright portion is the same as the tilt angle of the dark portion, the description thereof will be omitted.

That is, in the liquid crystal diffraction element according to the present embodiment, in the cholesteric liquid crystal layer having the dark portion that is tilted with respect to the surface of the cholesteric liquid crystal layer, the tilt angle of the dark portion with respect to the surface and the tilt angle of the liquid crystal compound may match each other in the entire region in the plane direction, may be different from each other in the entire region in the plane direction, or a region where the tilt angle of the dark portion with respect to the surface and the tilt angle of the liquid crystal compound match each other and a region where the tilt angle of the dark portion with respect to the surface and the tilt angle of the liquid crystal compound are different from each other may be mixed in the plane direction.

In addition, in the liquid crystal diffraction element according to the present embodiment, an aspect in which the tilt angle of the liquid crystal compound of the cholesteric liquid crystal layer 36 is uniform in the thickness direction is not limited. In the cholesteric liquid crystal layer 36 of the liquid crystal diffraction element according to the present embodiment, two or more regions in the thickness direction where the tilt angles of the liquid crystal compounds are different from each other may be present.

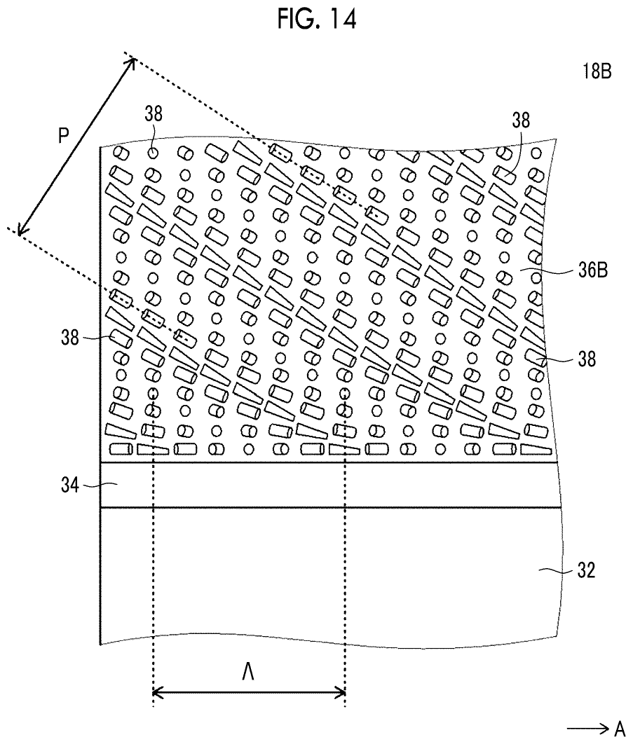

FIG. 14 is a cross-sectional view in the thickness direction conceptually showing another example of the liquid crystal diffraction element according to the present embodiment. A liquid crystal diffraction element 18B shown in FIG. 14 includes a substrate 32, an alignment film 34, and a cholesteric liquid crystal layer 36B.

As shown in the drawing, in the interface of the cholesteric liquid crystal layer 36B on the alignment film 34 side, the optical axis 38A of the liquid crystal compound 38 is parallel to the surface (does not have a tilt angle). In the cholesteric liquid crystal layer 36B, the tilt angle of the liquid crystal compound 38 increases as the distance from the interface on the alignment film 34 side increases in the thickness direction, and then the liquid crystal compound 38 is aligned at a constant tilt angle up to the surface (air interface) side of the liquid crystal diffraction element 18B.

As described above, the configuration of the cholesteric liquid crystal layer of the liquid crystal diffraction element according to the present embodiment may be a configuration in which the liquid crystal compound has a tilt angle with respect to one surface and the liquid crystal compound does not have a tilt angle with respect to the other surface, or may be a configuration in which the liquid crystal compound has a tilt angle with respect to both surfaces. In addition, in a case where the liquid crystal compound has a tilt angle with respect to both surfaces of the cholesteric liquid crystal layer, the tilt angles of the liquid crystal compound with respect to the respective surfaces may be the same as or different from each other.

In the cross-sectional SEM image of the cholesteric liquid crystal layer of the liquid crystal diffraction element according to the present embodiment, in a case where the bright portion and the dark portion extending from one surface to the other surface are present, the tilt angle of the dark portion with respect to the surface of the cholesteric liquid crystal layer may be uniform or different in the thickness direction. That is, at least two regions where the tilt angles of the dark portions are different from each other may be present in the thickness direction of the cholesteric liquid crystal layer.

In the cholesteric liquid crystal layer of the liquid crystal diffraction element according to the present embodiment, the tilt angle of the dark portion with respect to the surface of the cholesteric liquid crystal layer obtained from the cross-sectional SEM image and the tilt angle of the liquid crystal compound may match or may be different from each other in the thickness direction of the cholesteric liquid crystal layer.

That is, the tilt angle of the dark portion with respect to the surface of the cholesteric liquid crystal layer and the tilt angle of the liquid crystal compound may match in the entire region in the thickness direction of the cholesteric liquid crystal layer. In addition, in the thickness direction of the cholesteric liquid crystal layer, a region where the tilt angle of the dark portion with respect to the surface and the tilt angle of the liquid crystal compound are different from each other may be present, or the tilt angle of the dark portion with respect to the surface and the tilt angle of the liquid crystal compound may be different from each other in the entire region in the thickness direction.

In the cholesteric liquid crystal layer, the angle of the dark portion (bright portion) with respect to the surface in the cross-sectional SEM image can be adjusted by the length of the one period in the liquid crystal alignment pattern and the magnitude of the twisted orientation of the liquid crystal compound in the thickness direction.

The helical twisted orientation of the liquid crystal compound in the cholesteric liquid crystal layer can be realized by adding a chiral agent to the liquid crystal composition for forming the cholesteric liquid crystal layer as described below. By selecting and adjusting the type and amount of the chiral agent to be added, the twisted direction of the liquid crystal compound and the degree of twisted orientation of the liquid crystal compound can be adjusted.

In the cholesteric liquid crystal layer, in a case where the retardation is measured from the normal direction of the main surface of the cholesteric liquid crystal layer and a direction tilted with respect to the normal direction, it is preferable that a region where the direction in which the retardation Re is minimum is tilted with respect to the normal direction is provided.

Here, the “direction in which the retardation Re is minimum (hereinafter, also referred to as “direction D_{R}”) is tilted with respect to the normal direction” means that the minimum value of the retardation Re of the cholesteric liquid crystal layer is a measured value in a case where measurement light is incident from the direction tilted with respect to the normal line of the main surface of the cholesteric liquid crystal layer. The retardation means a retardation in-plane orthogonal to the direction in which the measurement light is incident.

In the cholesteric liquid crystal layer, in at least one of the regions where the direction D_{R} in which the retardation Re is minimum is tilted with respect to the normal direction, a measured angle θ2, which is an angle between the direction D_{R} and the normal direction, and the absolute value of the optical axis tilt angle φ calculated from the average refractive index n of the cholesteric liquid crystal layer by the following expression (1) are preferably 5° to 85°, more preferably 10° to 80°, and still more preferably 15° to 70°.

sin|θ2|=n·sin φ (1)

The measured angle θ2 is an angle between the direction in which the retardation Re is minimum and the normal direction in a case where the measurement light is incident before passing through the air-side interface of the cholesteric liquid crystal layer.

Further, it is preferable that the cholesteric liquid crystal layer has a region where the direction D_{R} in which the retardation Re is minimum is tilted with respect to the normal direction and has a region where the direction D_{R} in which the retardation Re is minimum is different.

In a case where the cholesteric liquid crystal layer has the above-described region in-plane, a decrease in diffraction efficiency can be further suppressed even in a region where the one period in the liquid crystal diffraction element is short, and the amount of reflected light with respect to incidence light can be further improved.

In the plane of the cholesteric liquid crystal layer, it is preferable that the angle θ2 between the direction D_{R} and the normal line of the main surface of the cholesteric liquid crystal layer gradually changes.

In particular, it is more preferable that the angle θ2 also gradually changes as the one period ∧ in the liquid crystal alignment pattern of the cholesteric liquid crystal layer gradually changes in at least a part (more preferably the entirety) of the plane of the cholesteric liquid crystal layer, and it is still more preferable that the angle θ2 increases as the one period ∧ in the liquid crystal alignment pattern of the cholesteric liquid crystal layer decreases.

In a case where the cholesteric liquid crystal layer has the above-described configuration, the diffraction efficiency can be improved even in a region where the one period in the liquid crystal diffraction element is short, and the amount of reflected light with respect to incidence light can be further improved.

The above-described gradual change of the angle θ2 may be a continuous change or a stepwise change in which regions having the same angle are provided, and a region where the angle θ2 continuously changes and a region where the angle θ2 changes stepwise may be mixed.

In addition, it is preferable that the direction D_{R} is tilted with respect to the normal direction of the main surface of the cholesteric liquid crystal layer in a direction toward the diffraction direction of the reflected light with respect to specular reflection by the liquid crystal diffraction element.

That is, in a case where the liquid crystal diffraction element acts as a concave mirror that collects light as in the liquid crystal diffraction element 18 (cholesteric liquid crystal layer 36) shown in FIG. 1, it is preferable that the direction D_{R} is tilted with respect to the normal direction (direction perpendicular to the paper surface in FIG. 1) in a direction toward the center, that is, the light collection direction.

In addition, in a case where the liquid crystal diffraction element acts as a convex mirror that diverges reflected light, it is preferable that the direction D_{R} is tilted with respect to the normal direction of the main surface in a direction from the inner side to the outer side, that is, a direction in which light is diverged.

A region where the direction D_{R} is the normal direction of the main surface may be present in at least a part of the plane of the cholesteric liquid crystal layer.

In addition, the cholesteric liquid crystal layer may have a configuration where the direction D_{R} is tilted in the entire plane.

A method of measuring the direction D_{R} in which the retardation Re in the liquid crystal diffraction element (cholesteric liquid crystal layer) is minimum and a method of preparing the cholesteric liquid crystal layer having a region where the direction D_{R} in which the retardation Re is minimum is tilted with respect to the normal direction of the main surface will be described in the second embodiment.

In the example shown in FIG. 2, the liquid crystal diffraction element 18 has a configuration where only one cholesteric liquid crystal layer 36 is provided. However, the liquid crystal diffraction element according to the present embodiment may include a plurality of cholesteric liquid crystal layers.

In a case where the liquid crystal diffraction element includes a plurality of cholesteric liquid crystal layers, it is preferable that the lengths of the one periods and the helical pitches of the plurality of cholesteric liquid crystal layers are different from each other at any point in the plane.

For example, in a case where the liquid crystal diffraction element reflects light components having a plurality of wavelengths emitted from the image display element, it is preferable that the liquid crystal diffraction element includes a cholesteric liquid crystal layer that reflects light components having each wavelength. The selective reflection wavelength in the cholesteric liquid crystal layer depends on the helical pitch. Accordingly, the plurality of cholesteric liquid crystal layers can reflect light components having each wavelength by setting different helical pitches depending on each wavelength. In this case, it is necessary to match the diffraction directions (diffraction angles) of light components having each wavelength at a certain point (region) in the plane of the liquid crystal diffraction element 18A. Here, the reflection angle of light by the cholesteric liquid crystal layer having the liquid crystal alignment pattern also depends on the wavelength of light. Therefore, by setting an appropriate helical pitch for each cholesteric liquid crystal layer at any point in the plane, light components having different wavelengths can be reflected at the same diffraction angle. As a result, it is possible to increase the wavelength range of light to be subjected to reflective diffraction by the liquid crystal diffraction element and to increase the incidence angle range of light to be subjected to reflective diffraction, and thus it is possible to improve the dependence of the reflective diffraction efficiency on the incidence angle of incidence light.

For example, in a case where the image display element emits light components of three colors including red light, green light, and blue light, it is preferable that the liquid crystal diffraction element includes three cholesteric liquid crystal layers corresponding to the respective colors.

In a case where the first cholesteric liquid crystal layer reflects blue light, the second cholesteric liquid crystal layer reflects green light, and the third cholesteric liquid crystal layer reflects red light, the first to third cholesteric liquid crystal layers have different one periods A and helical pitches at any point in the plane. In a case where the lengths of the one periods A at any point in the plane of the first to third cholesteric liquid crystal layers are represented by ∧1, ∧2, and ∧3, it is preferable that the first to third cholesteric liquid crystal layers have a region where ∧1<∧2<∧3 is satisfied.

That is, the length of the one period ∧ may be increased as the helical pitch is longer and the cholesteric liquid crystal layer reflects light having a longer wavelength.

In addition, in a case where the liquid crystal diffraction element includes a plurality of cholesteric liquid crystal layers, only one cholesteric liquid crystal layer having a bright portion and a dark portion extending from one surface to another surface in the cross-sectional SEM image may be provided, or at least two cholesteric liquid crystal layers may be provided.

In a case where the liquid crystal diffraction element includes at least two cholesteric liquid crystal layers having a bright portion and a dark portion extending from one surface to another surface in the cross-sectional SEM image of the cholesteric liquid crystal layer, tilt angles of the dark portions with respect to the surface in the at least two cholesteric liquid crystal layers may be the same as or different from each other.

In a case where the liquid crystal diffraction element includes at least two cholesteric liquid crystal layers, it is preferable that the tilt angles of the dark portions with respect to the surface in the at least two cholesteric liquid crystal layers are different from each other. By having such a configuration, the diffraction efficiency of light by the liquid crystal diffraction element (optically anisotropic layer) can be improved.

In the liquid crystal diffraction element 18 of the present embodiment, the cholesteric liquid crystal layer 36 is formed of a liquid crystal composition including a rod-like liquid crystal compound or a disk-like liquid crystal compound, has the liquid crystal alignment pattern in which the liquid crystal compound 38 is aligned as described above, further has a region where the liquid crystal compound 38 has a tilt angle, and has a region where the tilt angle of the liquid crystal compound 38 varies in the plane.

The liquid crystal diffraction element can be prepared by forming the alignment film 34 having the alignment pattern corresponding to the above-described liquid crystal alignment pattern on the substrate 32, applying the liquid crystal composition to the alignment film 34, and curing the liquid crystal composition to form the cholesteric liquid crystal layer 36 consisting of the cured layer of the liquid crystal composition.

The liquid crystal composition for forming the cholesteric liquid crystal layer 36 contains a rod-like liquid crystal compound or a disk-like liquid crystal compound, and may further contain other components such as a leveling agent, an alignment control agent, a polymerization initiator, and an alignment assistant.

In addition, the cholesteric liquid crystal layer 36 may have a structure in which the alignment state of the liquid crystal compound in the cholesteric liquid crystalline phase is maintained. Typically, it is preferable that the structure in which a predetermined liquid crystal phase is fixed is a structure which is obtained by making the polymerizable liquid crystal compound to be in a state where a cholesteric liquid crystalline phase is aligned, polymerizing and curing the polymerizable liquid crystal compound with ultraviolet irradiation, heating, or the like to form a layer having no fluidity, and concurrently changing the state of the polymerizable liquid crystal compound into a state where the alignment state is not changed by an external field or an external force.

Meanwhile, in the structure in which a cholesteric liquid crystalline phase is fixed, it is sufficient that the optical properties of the cholesteric liquid crystalline phase are retained, and the liquid crystal compound may not exhibit liquid crystallinity. For example, the molecular weight of the polymerizable liquid crystal compound may be increased by the curing reaction and the liquid crystallinity may be lost.

In addition, it is desirable that the cholesteric liquid crystal layer 36 has a wide range with respect to the wavelength of incident light, and it is preferable that the cholesteric liquid crystal layer 36 is formed of a liquid crystal material having a birefringence index with reverse dispersion.

Examples of a material used for forming the cholesteric liquid crystal layer include a liquid crystal composition including a liquid crystal compound. The liquid crystal compound is preferably a polymerizable liquid crystal compound.

In addition, the liquid crystal composition used for forming the cholesteric liquid crystal layer may include a chiral agent, and may further include a surfactant, a polymerization initiator, a crosslinking agent, a polymerization inhibitor, an antioxidant, an ultraviolet absorber, a light stabilizer, a coloring material, metal oxide fine particles, and the like as necessary as long as optical performance and the like do not deteriorate.

In addition, the cholesteric liquid crystal layer may have a pitch gradient structure. As is well-known, the selective reflection center wavelength of the cholesteric liquid crystal layer is determined depending on the pitch of the helical structure in the cholesteric liquid crystalline phase. The pitch gradient structure is a structure in which the helical pitch changes in the film thickness direction. For example, FIG. 13 is a diagram schematically showing a stripe pattern in which bright portions 42 and dark portions 44 are alternately arranged, which is observed in a case where a cross section of the cholesteric liquid crystal layer is observed with a scanning electron microscope (SEM). The interval of the bright portions 42 and the interval P of the dark portions 44 correspond to the helical pitch.

In a case where the cholesteric liquid crystal layer has a pitch gradient structure, the helical pitch gradually increases (or decreases) from one surface side toward the other surface side of the cholesteric liquid crystal layer. In the cholesteric liquid crystal layer, by changing the helical pitch P in the thickness direction, the selective reflection wavelength can be widened.

### —Polymerizable Liquid Crystal Compound—

The polymerizable liquid crystal compound may be a rod-like liquid crystal compound or a disk-like liquid crystal compound.

Examples of the rod-like polymerizable liquid crystal compound include a rod-like nematic liquid crystal compound. As the rod-like nematic liquid crystal compound, azomethines, azoxys, cyanobiphenyls, cyanophenyl esters, benzoic acid esters, cyclohexane carboxylic acid phenyl esters, cyanophenylcyclohexanes, cyano-substituted phenylpyrimidines, alkoxy-substituted phenylpyrimidines, phenyldioxanes, tolans, or alkenylcyclohexylbenzonitriles are preferably used. Not only the above low molecular weight liquid crystal molecules but also high molecular weight liquid crystal molecules can be used.

The polymerizable liquid crystal compound is obtained by introducing a polymerizable group into the liquid crystal compound. Examples of the polymerizable group include an unsaturated polymerizable group, an epoxy group, and an aziridinyl group. Among these, an unsaturated polymerizable group is preferable, and an ethylenically unsaturated polymerizable group is more preferable. The polymerizable group can be introduced into the molecules of the liquid crystal compound using various methods. The number of polymerizable groups included in the polymerizable liquid crystal compound is preferably 1 to 6 and more preferably 1 to 3.

As the polymerizable rod-like liquid crystal compound, compounds described in Makromol. Chem., (1989), Vol. 190, p. 2255, Advanced Materials (1993), Vol. 5, p. 107, U.S. Pat. Nos. 4,683,327A, 5,622,648A, 5,770,107A, WO95/022586A, WO95/024455A, WO97/000600A, WO98/023580A, WO98/052905A, JP1989-272551A (JP-H1-272551A), JP1994-016616A (JP-H6-016616A), JP1995-110469A (JP-H7-110469A), JP1999-080081A (JP-H11-080081A), and JP2001-328973A can be used. Furthermore, as the rod-like liquid crystal compound, for example, the compounds described in JP1999-513019A (JP-H11-513019A) and JP2007-279688A can also be preferably used.

In addition, as a polymerizable liquid crystal compound other than the above-described examples, for example, such a cyclic organopolysiloxane compound having a cholesteric phase as described in JP1982-165480A (JP-S57-165480A) can be used. Further, as the above-described polymer liquid crystal compound, for example, a polymer in which a liquid crystal mesogenic group is introduced into the main chain, a side chain, or both the main chain and a side chain, a polymer cholesteric liquid crystal in which a cholesteryl group is introduced into a side chain, such a liquid crystal polymer as described in JP1997-133810A (JP-H9-133810A), and such a liquid crystal polymer as described in JP1999-293252A (JP-H11-293252A) can be used.

For example, compounds described in JP2007-108732A and JP2010-244038A can be preferably used as the disk-like liquid crystal compound.

In a case where the disk-like liquid crystal compound is used in the liquid crystal layer, the liquid crystal compound 38 rises in the thickness direction in the liquid crystal layer, and the optical axis 38A derived from the liquid crystal compound is defined as an axis perpendicular to a disc plane, that is, a so-called fast axis.

An addition amount of the polymerizable liquid crystal compound in the liquid crystal composition is preferably 75% to 99.9% by mass, more preferably 80% to 99% by mass, and still more preferably 85% to 98% by mass with respect to the mass of solid contents (mass excluding a solvent) of the liquid crystal composition.

Two or more polymerizable liquid crystal compounds may be used in combination. In a case where two or more kinds of polymerizable liquid crystal compounds are used in combination, an alignment temperature can be decreased.

—Chiral agent (optically active compound)—

The chiral agent has a function of inducing a helical structure of the cholesteric liquid crystalline phase. The chiral agent may be selected depending on the purpose since a twisted direction of a helix or a helical pitch (that is, an inclined surface pitch) induced by a compound varies.

The chiral agent is not particularly limited, and known compounds (for example, Liquid Crystal Device Handbook, section 4-3 in Chapter 3, chiral agent for twisted nematic (TN) and super twisted nematic (STN), p. 199, edited by Japan Society for the Promotion of Science, 142th Committee, 1989), isosorbide, and isomannide derivatives can be used.

The chiral agent generally includes asymmetric carbon atoms. However, an axially chiral compound or a planar chiral compound, which does not have asymmetric carbon atoms, can also be used as a chiral agent. Examples of the axially chiral compound or the planar chiral compound include binaphthyl, helicene, paracyclophane, and derivatives thereof. The chiral agent may include a polymerizable group. In a case where both the chiral agent and the liquid crystal compound have a polymerizable group, a polymer which includes a repeating unit derived from the polymerizable liquid crystal compound and a repeating unit derived from the chiral agent can be formed due to a polymerization reaction of a polymerizable chiral agent and the polymerizable liquid crystal compound. In this aspect, the polymerizable group of the polymerizable chiral agent is preferably the same polymerizable group as the polymerizable group of the polymerizable liquid crystal compound. Accordingly, the polymerizable group of the chiral agent is preferably an unsaturated polymerizable group, an epoxy group, or an aziridinyl group, more preferably an unsaturated polymerizable group, and still more preferably an ethylenically unsaturated polymerizable group.

In addition, the chiral agent may be a liquid crystal compound.

It is preferable that the chiral agent contains a photoisomerizable group because a pattern of a desired reflection wavelength corresponding to an emission wavelength can be formed by photo mask irradiation using actinic rays or the like after application and alignment. As the photoisomerizable group, an isomerizable site of a compound exhibiting photochromic properties, an azo group, an azoxy group, or a cinnamoyl group is preferable. Specific examples of the compound include compounds described in JP2002-80478A, JP2002-80851A, JP2002-179668A, JP2002-179669A, JP2002-179670A, JP2002-179681A, JP2002-179682A, JP2002-338575A, JP2002-338668A, JP2003-313189A, and JP2003-313292A.

The content of the chiral agent in the liquid crystal composition is preferably 0.01% to 200% by mole and more preferably 1% to 30% by mole with respect to the content molar amount of the liquid crystal compound.

The cholesteric liquid crystal layer having regions where the helical pitches are different from each other in-plane can be formed by using a chiral agent in which a helical twisting power (HTP) is changed by photoisomerization, dimerization, isomerization, dimerization, or the like due to irradiation with light, and irradiating each of the regions with light having a wavelength at which the HTP of the chiral agent is changed before curing of the liquid crystal composition or during curing of the liquid crystal composition with a changed irradiation amount.

For example, by using a chiral agent in which the HTP decreases during light irradiation, the HTP of the chiral agent decreases during light irradiation. Here, in a case where the irradiation amount of light is changed for each region, for example, in a region where the irradiation amount is large, the HTP is significantly reduced and the helical twisting is small, so that the helical pitch PT is long. On the other hand, for example, in a region that is irradiated with the light at a low irradiation dose, the decrease in HTP is small, helix is induced by the original HTP of the chiral agent, and thus the helical pitch PT decreases.

A method of changing the irradiation amount of light for each in-plane region is not particularly limited, and a method of irradiating light through a gradation mask, a method of changing an irradiation time for each region, a method of changing an irradiation intensity for each region, and the like can be used.

The gradation mask refers to a mask in which a transmittance with respect to light for irradiation changes in-plane.

The above-described material for forming the cholesteric liquid crystal layer, the above-described method of preparing the cholesteric liquid crystal layer, and the above-described exposure method of the alignment film for aligning the cholesteric liquid crystal layer are described in WO2019/189852A.

The thickness of the cholesteric liquid crystal layer is not particularly limited, and the thickness with which a required light reflectivity can be obtained may be appropriately set depending on the use of the liquid crystal diffraction element 18, the light reflectivity required for the cholesteric liquid crystal layer, the material for forming the cholesteric liquid crystal layer, and the like.

Hereinafter, other members other than the cholesteric liquid crystal layer that may be provided in the liquid crystal diffraction element and a method of manufacturing the liquid crystal diffraction element will be described using FIG. 2 as an example.

As described above, the liquid crystal diffraction element 18 shown in FIG. 2 includes a substrate 32, an alignment film 34, and the above-described cholesteric liquid crystal layer 36.

As the substrate 32 constituting the liquid crystal diffraction element 18, various sheet-like materials can be used as long as the substrate 32 can support the alignment film 34 and the cholesteric liquid crystal layer 36.

As the substrate 32, a transparent support is preferable, and examples thereof include a polyacrylic resin film such as polymethyl methacrylate, a cellulose-based resin film such as cellulose triacetate, a cycloolefin polymer-based film (for example, trade name “ARTON”, manufactured by JSR Corporation; or trade name “ZEONOR”, manufactured by Zeon Corporation), polyethylene terephthalate (PET), polycarbonate, and polyvinyl chloride. The support is not limited to a flexible film and may be a non-flexible substrate such as a glass substrate.

The alignment film 34 is formed on a surface of the substrate 32.

The liquid crystal alignment pattern in the cholesteric liquid crystal layer 36 follows the alignment pattern formed on the alignment film 34. Accordingly, the alignment film 34 for forming the liquid crystal layer having the liquid crystal alignment pattern is formed with the same alignment pattern as the liquid crystal alignment pattern in the cholesteric liquid crystal layer 36.

The alignment film 34 having such an alignment pattern can be formed by, for example, forming a coating film including a compound having a photo-aligned group, drying the coating film, and exposing the coating film with an exposure device described below.

Preferable examples of the compound having a photo-aligned group, that is, a photo-alignment material used in a photo-alignment film include: an azo compound described in JP2006-285197A, JP2007-076839A, JP2007-138138A, JP2007-094071A, JP2007-121721A, JP2007-140465A, JP2007-156439A, JP2007-133184A, JP2009-109831A, JP3883848B, and JP4151746B; an aromatic ester compound described in JP2002-229039A; a maleimide- and/or alkenyl-substituted nadiimide compound having a photo-alignable unit described in JP2002-265541A and JP2002-317013A; a photocrosslinking silane derivative described in JP4205195B and JP4205198B, a photocrosslinking polyimide, a photocrosslinking polyamide, or a photocrosslinking ester described in JP2003-520878A, JP2004-529220A, and JP4162850B; and a photodimerizable compound, in particular, a cinnamate compound, a chalcone compound, or a coumarin compound described in JP1997-118717A (JP-H9-118717A), JP1998-506420A (JP-H10-506420A), JP2003-505561A, WO2010/150748A, JP2013-177561A, and JP2014-12823A.

Among the photo-alignment materials, the azo compound, the photocrosslinkable polyimide, the photocrosslinkable polyamide, the photocrosslinkable ester, the cinnamate compound, and the chalcone compound are suitably used.

In this way, the coating film serving as the alignment film 34 (photo-alignment film) for forming the cholesteric liquid crystal layer 36 is exposed to light to form an alignment pattern corresponding to the concentric liquid crystal alignment pattern in which the optical axis changes while continuously rotating in a radial shape.

Here, before exposing the concentric liquid crystal alignment pattern to light, the alignment film 34 can be formed by irradiating the alignment film 34 with unpolarized light while changing the irradiation amount and the irradiation angle to tilt-align the liquid crystal compound in the cholesteric liquid crystal layer 36. Specifically, as the irradiation amount of the unpolarized light is increased and the irradiation angle with respect to the surface is increased (that is, as the polar angle is decreased), the tilt angle of the liquid crystal compound 38 in the cholesteric liquid crystal layer 36 can be increased.

For example, the unpolarized light is incident into the alignment film 34 such that an incidence angle gradually decreases and an irradiation amount gradually increases from the center of the alignment film 34 toward the outer direction, with the normal direction of the alignment film 34 being 0° (polar angle: 0°) and the plane direction of the alignment film 34 being 90° (polar angle: 90°). That is, in the reflective type liquid crystal diffraction element shown in FIG. 1, the unpolarized light is incident into the alignment film 34 in a concentric shape such that the incidence angle gradually decreases and the irradiation amount gradually increases from the optical axis at the center toward the outward direction in the radial direction (concentric).

As a result, the alignment film 34 can be formed in which the liquid crystal compound 38 is tilt-aligned such that the tilt angle of the liquid crystal compound 38 gradually increases from the center portion toward the inner side and the outer side as shown in FIG. 3, without the tilt angle of the liquid crystal compound 38 in the center portion.

In this way, after the alignment film 34 is exposed to tilt-align the liquid crystal compound 38, the alignment film 34 is exposed to form the alignment pattern corresponding to the concentric circular liquid crystal alignment pattern in which the optical axis changes while continuously rotating in a radial shape.

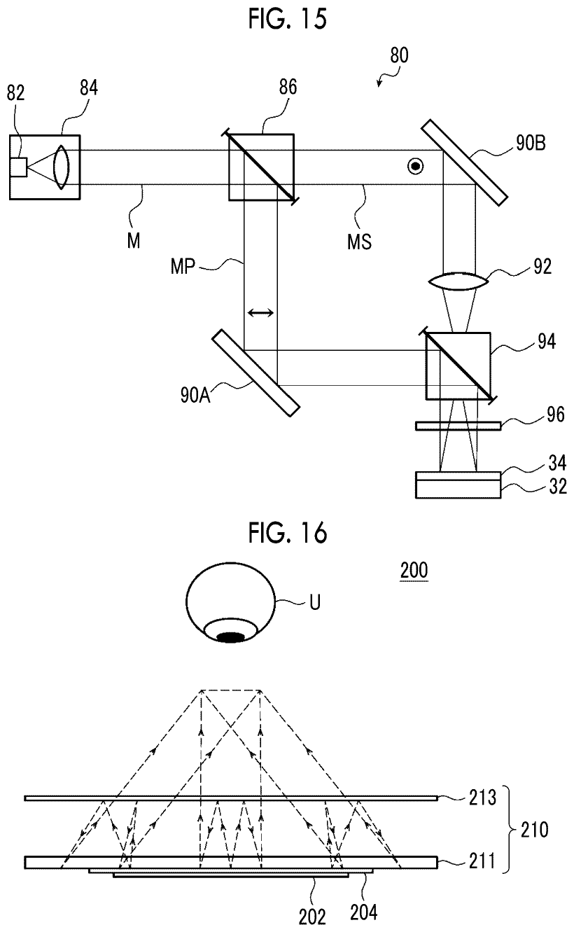

FIG. 15 conceptually shows an example of an exposure device that exposes a coating film serving as the alignment film 34 (photo-alignment film) for forming the cholesteric liquid crystal layer 36 to light to form an alignment pattern corresponding to the concentric liquid crystal alignment pattern in which the optical axis changes while continuously rotating in a radial shape.

An exposure device 80 shown in FIG. 15 includes a light source 84 which includes a laser 82, a polarization beam splitter 86 which splits a laser light M emitted from the laser 82 into an S-polarized light MS and a P-polarized light MP, a mirror 90A which is disposed on an optical path of the P-polarized light MP and a mirror 90B which is disposed on an optical path of the S-polarized light MS, a lens 92 which is disposed on the optical path of the S-polarized light MS, a polarization beam splitter 94, and a λ/4 plate 96.

The P-polarized light MP which is split by the polarization beam splitter 86 is reflected from the mirror 90A to be incident into the polarization beam splitter 94. On the other hand, the S-polarized light MS that is split by the polarization beam splitter 86 is reflected from the mirror 90B and is collected by the lens 92 to be incident into the polarization beam splitter 94.

The P-polarized light MP and the S-polarized light MS are combined by the polarization beam splitter 94, are converted into right circularly polarized light and left circularly polarized light by the λ/4 plate 96 depending on the polarization direction, and are incident into the alignment film 34 on the substrate 32.

Due to interference between the right circularly polarized light and the left circularly polarized light, the polarization state of light with which the alignment film 34 is irradiated periodically changes according to interference fringes. Since an intersecting angle between the left circularly polarized light and the right circularly polarized light changes from an inside toward an outside of concentric circles, an exposure pattern in which pitches change from the inside toward the outside is obtained. Accordingly, a radial (concentric) alignment pattern in which the alignment states periodically change is obtained in the alignment film 34.

In the exposure device 80, the one period ∧ of the liquid crystal alignment pattern in which the optical axis of the liquid crystal compound 38 continuously rotates by 180° in the one direction can be controlled by changing a focal power of the lens 92, the focal length of the lens 92, the distance between the lens 92 and the alignment film 34, and the like.

In addition, by adjusting the focal power of the lens 92 (F number of the lens 92), the length of the one period of the liquid crystal alignment pattern in which the optical axis continuously rotates in the one direction can be changed.

Specifically, the length of one period of the liquid crystal alignment pattern can be changed in one direction in which the optical axes continuously rotate, using a spread angle of light that is spread by the lens 92 to interfere with parallel light. More specifically, in a case where the focal power of the lens 92 is decreased, the light is close to the parallel light, so that the length ∧ of the one period in the liquid crystal alignment pattern is gradually decreased from the inner side toward the outer side. Conversely, in a case where the optical power of the lens 92 is increased, the length ∧ of the one period in the liquid crystal alignment pattern rapidly decreases from the inner side toward the outer side.

That is, by adjusting the refractive index of the lens 92, the refractive index of the liquid crystal diffraction element 18 (cholesteric liquid crystal layer 36) that acts as a concave lens or a convex lens depending on the revolution direction of the incident circularly polarized light can be adjusted.

By applying the above-described liquid crystal composition for forming the cholesteric liquid crystal layer 36 to the exposed alignment film 34 formed as described above, drying the applied liquid crystal composition, and curing the dried liquid crystal composition by ultraviolet irradiation or the like as necessary, the cholesteric liquid crystal layer 36 having the concentric liquid crystal alignment pattern as described above, having a region where the liquid crystal compound 38 has a tilt angle, and having regions where the tilt angles of the liquid crystal compound 38 are different in-plane can be formed, and thus the liquid crystal diffraction element 18 as shown in FIGS. 1 and 2 can be manufactured.

In the liquid crystal diffraction element according to the present embodiment described above, the cholesteric liquid crystal layer has the concentric liquid crystal alignment pattern as shown in FIG. 1. However, the present embodiment is not limited thereto.

For example, in the liquid crystal diffraction element according to the present embodiment, the cholesteric liquid crystal layer may have a linear liquid crystal alignment pattern in the one in-plane direction (arrow A direction) as shown in FIG. 5. Such a linear liquid crystal alignment pattern can be formed by exposing the alignment film using a known method such as a method with an exposure device described in FIG. 8 of JP7200383B.

In addition, in a case where the one period of the linear liquid crystal alignment pattern in the one in-plane direction (arrow A direction) changes in-plane, the liquid crystal diffraction element acts as, for example, a reflective type liquid crystal diffraction element that collects light in a linear shape or a reflective type liquid crystal diffraction element that emits light in two directions opposite to each other.

### Second Embodiment

A liquid crystal diffraction element according to a second embodiment of the present invention includes a cholesteric liquid crystal layer, in which the cholesteric liquid crystal layer has a liquid crystal alignment pattern in which an orientation of an optical axis derived from a liquid crystal compound changes while continuously rotating in at least one in-plane direction, in a case where a retardation is measured from a normal direction of a main surface of the cholesteric liquid crystal layer and a direction tilted with respect to the normal direction, the cholesteric liquid crystal layer has a region where a direction in which the retardation is minimum is tilted with respect to the normal direction, and the cholesteric liquid crystal layer has regions where a direction D_{R} in which a retardation Re is minimum is different in-plane.

Regarding the configuration of the liquid crystal diffraction element according to the present embodiment, the drawings used in the description of the liquid crystal diffraction element according to the first embodiment can be referred to, and the present embodiment will be described with reference to the above-described drawings as necessary.

The present inventors have found that, in a case where the liquid crystal diffraction element includes the cholesteric liquid crystal layer having the liquid crystal alignment pattern in which the orientation of the optical axis changes while continuously rotating in at least one in-plane direction, in which the cholesteric liquid crystal layer has the region where the direction D_{R} is tilted with respect to the normal direction and has the regions where the direction D_{R} is different in-plane, a decrease in diffraction efficiency can be further suppressed and the amount of reflected light with respect to incidence light can be further improved even in a region where the one period ∧ of the liquid crystal alignment pattern is short, in particular, a region where the one period ∧ of the liquid crystal alignment pattern is 1 μm or less.

The liquid crystal diffraction element according to the present embodiment can obtain excellent diffraction efficiency by having the above-described configuration. Therefore, according to the liquid crystal diffraction element according to the present embodiment, for example, in a case where the liquid crystal diffraction element is used for a concave mirror having a short focal length, light can be collected with high light collection efficiency.

In the present embodiment, in at least one of the regions where the direction D_{R} is tilted with respect to the normal direction, a measured angle θ2, which is an angle between the direction D_{R} and the normal direction, and an absolute value of an optical axis tilt angle q calculated from an average refractive index n of the cholesteric liquid crystal layer by the following expression (1) are preferably 5° to 85°, more preferably 10° to 80°, and still more preferably 15° to 70°.

sin|θ2|=n·sin φ (1)

The measured angle θ2 is an angle between the direction in which the retardation Re is minimum and the normal direction in a case where the measurement light is incident before passing through the air-side interface of the cholesteric liquid crystal layer.

In a plane of the cholesteric liquid crystal layer, it is preferable that the angle θ2 between the direction D_{R} and the normal direction of the main surface of the cholesteric liquid crystal layer gradually changes.

In particular, it is more preferable that the angle θ2 also gradually changes as the one period ∧ in the liquid crystal alignment pattern of the cholesteric liquid crystal layer gradually changes in at least a part (more preferably the entirety) of the plane of the cholesteric liquid crystal layer, and it is still more preferable that the angle θ2 increases as the one period ∧ in the liquid crystal alignment pattern of the cholesteric liquid crystal layer decreases.

In a case where the cholesteric liquid crystal layer has the above-described configuration, the diffraction efficiency can be improved even in a region where the one period in the liquid crystal diffraction element is short, and the amount of reflected light with respect to incidence light can be further improved.

The above-described gradual change of the angle θ2 may be a continuous change or a stepwise change in which regions having the same angle are provided, and a region where the angle θ2 continuously changes and a region where the angle θ2 changes stepwise may be mixed.

In addition, it is preferable that the direction D_{R} is tilted with respect to the normal direction of the main surface of the cholesteric liquid crystal layer in a direction toward the diffraction direction of the reflected light with respect to specular reflection by the liquid crystal diffraction element.

That is, in a case where the liquid crystal diffraction element acts as a concave mirror that collects light as in the liquid crystal diffraction element 18 (cholesteric liquid crystal layer 36) shown in FIG. 1, it is preferable that the direction D_{R} is tilted with respect to the normal direction (direction perpendicular to the paper surface in FIG. 1) in a direction toward the center, that is, the light collection direction.

In addition, in a case where the liquid crystal diffraction element acts as a convex mirror that diverges reflected light, it is preferable that the direction D_{R} is tilted with respect to the normal direction of the main surface in a direction from the inner side to the outer side, that is, a direction in which light is diverged.

A region where the direction D_{R} is the normal direction of the main surface may be present in at least a part of the plane of the cholesteric liquid crystal layer.

In addition, the cholesteric liquid crystal layer may have a configuration where the direction D_{R} is tilted in the entire plane.

A measuring method of measuring the direction D_{R} in the cholesteric liquid crystal layer of the liquid crystal diffraction element will be described.

The direction D_{R} in which the above-described retardation Re is minimum can be detected by measuring the retardation Re of the cholesteric liquid crystal layer by causing measurement light to be incident from the normal direction of the main surface of the cholesteric liquid crystal layer and further measuring the retardation Re of the cholesteric liquid crystal layer by sequentially changing the incidence direction of the measurement light (incidence angle with respect to the normal line). The retardation means a retardation in-plane orthogonal to the direction in which the measurement light is incident.

The retardation Re is measured by calculating the slow axis direction by the above-described method using a polarized light phase difference analyzer AxoScan (manufactured by Axometrics, Inc.), and then sequentially tilting the measurement light in-plane (slow axis plane) that is perpendicular to the main surface of the cholesteric liquid crystal layer and includes the slow axis of the cholesteric liquid crystal layer and a plane (fast axis plane) that is perpendicular to the main surface of the cholesteric liquid crystal layer and includes a direction (fast axis) perpendicular to the slow axis of the cholesteric liquid crystal layer in-plane.

The measurement light used for measuring the retardation Re is preferably light having a wavelength outside the selective reflection wavelength range of the cholesteric liquid crystal layer, and for example, infrared light that is invisible light is preferable.

In the cholesteric liquid crystal layer of the present embodiment, in general, the fast axis plane coincides with a direction in which the optical axis continuously rotates in the in-plane direction, that is, the arrow A direction, and the slow axis direction coincides with a direction orthogonal to the direction in which the optical axis continuously rotates in the plane.

A manufacturing method of the cholesteric liquid crystal layer of the liquid crystal diffraction element according to the present embodiment, which has a region where the direction D_{R} is tilted with respect to the normal direction and has regions where the direction D_{R} varies in-plane, is not particularly limited, and examples thereof include a method of tilt-aligning a liquid crystal compound included in the cholesteric liquid crystal layer in a region where the direction D_{R} is tilted with respect to the normal direction. By adjusting the tilt alignment angle (tilt angle) and direction of the liquid crystal compound, the direction D_{R} in which the retardation Re in the in-plane region of the cholesteric liquid crystal layer is minimum can be adjusted.

The manufacturing method of the cholesteric liquid crystal layer in which the liquid crystal compound is tilt-aligned and the method of adjusting the tilt angle and the like are as described in the first embodiment.

In the present embodiment, it is preferable that at least one surface of the cholesteric liquid crystal layer has a region where the liquid crystal compound has a tilt angle with respect to the surface of the cholesteric liquid crystal layer, and the cholesteric liquid crystal layer has regions where the tilt angle of the liquid crystal compound with respect to the surface of the cholesteric liquid crystal layer varies in-plane.

In a case where the cholesteric liquid crystal layer has the above-described region in-plane, a decrease in diffraction efficiency can be further suppressed even in a region where the one period in the liquid crystal diffraction element is short, and the amount of reflected light with respect to incidence light can be further improved.

In at least a part (more preferably, the entirety) of the cholesteric liquid crystal layer in-plane, it is preferable that the tilt angle of the liquid crystal compound with respect to the surface of the cholesteric liquid crystal layer gradually changes, and in at least a part (more preferably, the entirety) of the cholesteric liquid crystal layer in-plane, it is more preferable that the tilt angle of the liquid crystal compound also gradually changes as the one period ∧ in the liquid crystal alignment pattern of the cholesteric liquid crystal layer gradually changes.

In particular, in the liquid crystal diffraction element (cholesteric liquid crystal layer), in consideration of the fact that the diffraction efficiency decreases as the one period ∧ in the liquid crystal alignment pattern decreases, it is more preferable that the tilt angle of the liquid crystal compound increases as the one period ∧ decreases in at least a part (more preferably, the entirety) of the liquid crystal alignment pattern of the cholesteric liquid crystal layer.

However, the liquid crystal diffraction element according to the present embodiment is not limited to the above-described aspects. The tilt angle of the liquid crystal compound with respect to the surface of the cholesteric liquid crystal layer may be constant in-plane or may vary in-plane. The tilt angle of the liquid crystal compound with respect to the surface of the cholesteric liquid crystal layer may decrease in conjunction with a decrease in the one period A in the liquid crystal alignment pattern, or the tilt angle of the liquid crystal compound may not be linked to a change in the one period ∧ in the liquid crystal alignment pattern.

Regarding the liquid crystal diffraction element according to the present embodiment, the composition of the cholesteric liquid crystal layer including the liquid crystal compound, the structure and physical properties (optical and physical) of the cholesteric liquid crystal layer including the tilt angle of the liquid crystal compound, the method of forming the cholesteric liquid crystal layer, and the like are the same as those of the liquid crystal diffraction element according to the first embodiment described above, including suitable aspects thereof.

In the cholesteric liquid crystal layer of the liquid crystal diffraction element according to the present embodiment, the tilt angle of the dark portion with respect to the surface of the cholesteric liquid crystal layer obtained from the cross-sectional SEM image and the measurement angle θ2, which is an angle between the direction D_{R} and the normal direction of the main surface of the cholesteric liquid crystal layer, may match or may be different from each other in the thickness direction of the cholesteric liquid crystal layer.

That is, the tilt angle of the dark portion with respect to the surface of the cholesteric liquid crystal layer and the measurement angle θ2 may match in the entire region of the cholesteric liquid crystal layer in the thickness direction. In addition, in the thickness direction of the cholesteric liquid crystal layer, a region where the tilt angle of the dark portion with respect to the surface and the measurement angle θ2 are different from each other may be present, or the tilt angle of the dark portion with respect to the surface and the tilt angle of the liquid crystal compound may be different from each other in the entire region in the thickness direction.

In the liquid crystal diffraction element according to the present embodiment, it is preferable that the measurement angle θ2, which is an angle between the direction D_{R} in which the retardation Re is minimum and the normal direction of the main surface of the cholesteric liquid crystal layer, and the traveling direction of light in the cholesteric liquid crystal layer are close to each other. That is, in the liquid crystal diffraction element according to the present embodiment, it is preferable that the angle θ2 between the direction D_{R} and the normal direction and the angle between the traveling direction of light in the cholesteric liquid crystal layer and the normal direction of the main surface are close to each other.

More specifically, in an optical device including the liquid crystal diffraction element according to the present embodiment and a light source that emits light to the liquid crystal diffraction element, in a case where an angle of incidence of incident light incident into the cholesteric liquid crystal layer (liquid crystal diffraction element) from the light source is denoted by θin, a refractive index of the cholesteric liquid crystal layer is denoted by nG, and an emission angle of first-order light reflected by the cholesteric liquid crystal layer (liquid crystal diffraction element) is denoted by θm, it is preferable that the angle θ2 [°] between the direction D_{R} and the normal direction satisfies Expressions (B1) to (B3).

$$θ2 [ ° ] = ( θ G [ ° ] - θ r [ ° ] ) / 2 \pm 15 [ ° ] \qquad ( B1 )$$

$$sin θ G = sin θ m / nG \qquad ( B2 )$$

$$sin θ r = sin θ in / nG \qquad ( B3 )$$

Expression (B1) can be rewritten as Expression (B4).

$$( θ G [ ° ] - θ r [ ° ] ) / 2 - 15 ° \leq θ2 [ ° ] \leq ( θ G [ ° ] - θ r [ ° ] ) / 2 + 15 ° \qquad ( B4 )$$

With such a configuration, a liquid crystal diffraction element having an excellent diffraction efficiency can be obtained even in a case where the one period ∧ of the liquid crystal alignment pattern in the cholesteric liquid crystal layer is short. In particular, in a case where the diffraction angle is large, from the viewpoint of obtaining a liquid crystal diffraction element having excellent diffraction efficiency and excellent polarization properties (high circular polarization degree), it is preferable.

In a case where the liquid crystal diffraction element according to the present embodiment includes a plurality of cholesteric liquid crystal layers, the refractive index nG of the cholesteric liquid crystal layer is the same as that in the first embodiment, and the angle θ2 between the direction D_{R} and the normal direction can be calculated using the average angle of a plurality of cholesteric liquid crystal layers calculated in consideration of the thickness of each layer based on the tilt angle θP [°] of the liquid crystal compound in the first embodiment.

In addition, a member or the like other than the cholesteric liquid crystal layer in the liquid crystal diffraction element according to the present embodiment is also the same as that of the liquid crystal diffraction element according to the first embodiment described above including a suitable aspect thereof.

Hereinafter, characteristics of the liquid crystal diffraction element according to the embodiment of the present invention will be described without distinction between the first embodiment and the second embodiment.

The liquid crystal diffraction element according to the embodiment of the present invention and an optical device including the liquid crystal diffraction element according to the embodiment of the present invention described below may include an adhesion layer for adhesion to other members. In the present specification, the “adhesive” is used as a concept including “pressure-sensitive adhesive”.

Examples of the adhesive include a water-soluble adhesive, an ultraviolet curable adhesive, an emulsion type adhesive, a latex type adhesive, a mastic adhesive, a multi-layered adhesive, a paste-like adhesive, a foaming adhesive, a supported film adhesive, a thermoplastic adhesive, a hot-melt adhesive, a thermally solidified adhesive, a thermally activated adhesive, a heat-seal adhesive, a thermosetting adhesive, a contact type adhesive, a pressure-sensitive adhesive, a polymerizable adhesive, a solvent type adhesive, a solvent-activated adhesive, and a ceramic adhesive.

Specific examples thereof include a boron compound aqueous solution, a curable adhesive of an epoxy compound not having an aromatic ring in a molecule, as described in JP2004-245925A; an active energy ray-curable adhesive having a molar absorption coefficient of 400 or more at a wavelength of 360 to 450 nm and containing a photopolymerization initiator and an ultraviolet curable compound as essential components, as described in JP2008-174667A; and an active energy ray-curable adhesive containing (a) a (meth)acrylic compound having two or more (meth)acryloyl groups in a molecule, (b) a (meth)acrylic compound having a hydroxyl group and only one polymerizable double bond in a molecule, and (c) a phenol ethylene oxide modified acrylate or a nonyl phenol ethylene oxide modified acrylate with respect to 100 parts by mass of the total amount of the (meth)acrylic compounds, as described in JP2008-174667A. These adhesives may be used alone or may be used in combination as necessary.

From the viewpoint of reducing unnecessary reflection, it is preferable that the adhesion layer has a small difference in refractive index with an adjacent layer. Specifically, the difference in refractive index with the adjacent layer is preferably 0.05 or less and more preferably 0.01 or less. A method of adjusting the refractive index of the adhesion layer is not particularly limited, and for example, a known method such as a method of adding fine particles of zirconia, silica, acryl, acrylic-styrene, melamine, or the like, a method of adjusting the refractive index by a resin, and a method described in JP1999-223712A (JP-H11-223712A) can be used.

In addition, in a case where the adjacent layer has refractive index anisotropy in-plane, it is preferable that the difference in refractive index from the adjacent layer in all of the in-plane directions is 0.05 or less. Therefore, the adhesion layer may have refractive index anisotropy in-plane.

In a case where a difference in refractive index between adhesion interfaces is large, an interface reflectivity can be reduced by generating a refractive index distribution in the thickness direction of the adhesion layer. Examples of a method of generating the refractive index distribution in the thickness direction include a method of providing a plurality of adhesion layers, a method of mixing interfaces between a plurality of adhesion layers provided, and a method of controlling an uneven distribution state of a material in the adhesion layer to generate the refractive index distribution.

In addition, the adhesion layer can be provided on one member or both members to be bonded using any method such as application, vapor deposition, or transfer, and from the viewpoint of increasing an adhesion strength, a post-treatment such as a heating treatment and ultraviolet irradiation can be performed according to the type of the adhesive.

The thickness of the adhesion layer can be randomly adjusted, but is preferably 20 μm or less and more preferably 0.1 μm or less. Examples of a method of forming the adhesion layer having a thickness of 0.1 μm or less include a method of vapor-depositing a ceramic adhesive such as silicon oxide (SiOₓ layer) on the bonding surface.

For the bonding surface of the bonding member, before the bonding, for example, a surface reforming treatment such as a plasma treatment, a corona treatment, and a saponification treatment can be performed, and a primer layer can be applied. In addition, in a case where a plurality of bonding surfaces are present, the kind and thickness of the adhesion layer can be adjusted for each of the bonding surfaces.

The laminate produced using the liquid crystal diffraction element according to the embodiment of the present invention can be cut into a predetermined size.

A method of cutting the laminate is not particularly limited, and for example, various known methods such as a method of physically cutting the laminate using a blade such as a Thomson blade and a method of cutting the laminate by laser irradiation can be used. In a case where the laser is used, it is preferable to select a pulse width (nanoseconds, picoseconds, or femtoseconds) and a wavelength in consideration of cuttability, damage to a material, and the like. In addition, after processing the laminate in a predetermined shape, for example, edge surface polishing may be performed.

From the viewpoint of improving workability during cutting and suppressing dust generation, the liquid crystal diffraction element can also be cut in a state in which a peelable protective film is attached. In addition, for example, by cutting the liquid crystal diffraction element while observing the liquid crystal alignment pattern by a method described in JP2004-141889A, a cutting position can be optionally determined. In this case, in order to easily see the liquid crystal alignment pattern, the liquid crystal alignment pattern can also be observed through the polarizing plate, the phase difference film, and the like. In addition, in a case where a plurality of optical elements are provided on one substrate, it is preferable that the plurality of optical elements are cut at the same time.

In the laminate including the liquid crystal diffraction element according to the embodiment of the present invention, a mark having any shape can be added as necessary for the purpose of accurately installing the laminate in a device, improving the accuracy of the axis and the cutting position during cutting, and the like. The kind of the mark can be freely selected, and a method of physically forming the mark using a laser, an ink jet method, or the like, a method of partially changing the alignment state of the liquid crystal, a method of forming a region which is partially decolored or colored, or the like can be selected.

In addition, in order to protect the liquid crystal layer, optionally, a protective layer (a gas barrier layer, a layer for blocking moisture or the like, an ultraviolet absorbing layer, a scratch resistance layer, or the like) can be provided. The protective layer can be directly formed on the liquid crystal layer, or may be provided through a pressure-sensitive adhesion layer, another optical film, or the like. An antireflection layer (a low reflection (LR) layer, an anti reflective (AR) layer, a moth-eye layer, or the like) may be provided for the purpose of reducing reflectivity of the surface. Various protective layers can be appropriately selected from well-known protective layers. In a case where the gas barrier layer is provided polyvinyl alcohol is preferable. The polyvinyl alcohol can also serve as a polarizer. In addition, the ultraviolet absorbing layer is a layer including an ultraviolet absorber. As the ultraviolet absorber, from the viewpoints of excellent capability to absorb ultraviolet light having a wavelength of 370 nm or less and excellent display properties, an ultraviolet absorber having small absorption of visible light having a wavelength of 400 nm or more is preferably used. As the ultraviolet absorber, one kind may be used alone, or two or more kinds may be used in combination. Examples thereof include ultraviolet absorbers described in JP2001-072782A and JP2002-543265A. Specific examples of the ultraviolet absorber include an oxybenzophenone-based compound, a benzotriazole-based compound, a salicylic acid ester-based compound, a benzophenone-based compound, a cyanoacrylate-based compound, and a nickel complex salt-based compound.

### [Applications of Liquid Crystal Diffraction Element]

That is, the liquid crystal diffraction element according to the embodiment of the present invention can be used as an optical unit in combination with various members.

In addition, the liquid crystal diffraction element according to the embodiment of the present invention and the optical unit including the liquid crystal diffraction element according to the embodiment of the present invention can be used as an optical module in combination with various members.

Furthermore, the liquid crystal diffraction element according to the embodiment of the present invention, the optical unit (optical element) including the liquid crystal diffraction element according to the embodiment of the present invention, and the optical module including the liquid crystal diffraction element according to the embodiment of the present invention can be used in various optical devices.

Among these, the liquid crystal diffraction element according to the embodiment of the present invention is preferably used in an optical device including the liquid crystal diffraction element according to the embodiment of the present invention and a light source that emits light to the liquid crystal diffraction element.

Examples of the optical device including the liquid crystal diffraction element according to the embodiment of the present invention and the light source include a head-mounted display, a virtual reality (VR) display device, a sensor, and a communication device.

In the optical device according to the embodiment of the present invention, the light source is not limited, and various known light sources can be used.

Accordingly, the light source may be a light source which emits white light, a light source which emits monochromatic light such as red light, green light, and blue light, or various image display elements such as a liquid crystal display and an organic electroluminescent display. Since the liquid crystal diffraction element according to the embodiment of the present invention can be suitably used as a reflective type liquid crystal diffraction element in a VR system such as a head-mounted display, various image display elements are suitably exemplified as the light source.

Hereinafter, application examples of the optical device according to the embodiment of the present invention will be described.

### Application Example of Optical Device

FIG. 16 conceptually shows an example of an image display device including the optical device according to the embodiment of the present invention.

An image display device (virtual reality display device) 200 shown in FIG. 16 includes an image display element 202, a circular polarization plate 204, and an optical unit 210 in this order. The optical unit 210 includes a first partial reflection element 211 and a second partial reflection element 213.

The image display element 202 is a known display. Examples of the image display element 202 include a liquid crystal display element (liquid crystal display (LCD)), an organic electroluminescent display element (organic light emitting diode (OLED)), a cathode-ray tube (CRT), a plasma display element, an electronic paper, a light emitting diode (LED) display element, a micro LED display element, digital light processing (DLP), and a micro-electro-mechanical systems (MEMS) type display element. In the present invention, the liquid crystal display element includes liquid crystal on silicon (LCOS) and the like. In addition, the image display element may be a transparent display capable of transmitting light.

The image display element may display a monochrome image, a two-color image, or a color image.

In addition, the light emitted from the image display element may be unpolarized light, linearly polarized light, or circularly polarized light. In addition, an element (for example, a linear polarizer or a circular polarization plate) that converts the polarization state of light may be provided on a display surface (visible) side of the image display element. In the example shown in FIG. 16, a circular polarization plate 204 is provided on the display surface side of the image display element 202. The circular polarization plate 204 has a configuration including, for example, a linear polarizer and a λ/4 retardation plate.

The linear polarizer is not limited. Accordingly, the linear polarizer may be a reflective type polarizer or an absorptive type polarizer, and various known linear polarizers such as an iodine-based polarizer, a dye-based polarizer using a dichroic dye, a polyene-based polarizer, a wire grid polarizer, and a film obtained by stretching a dielectric multi-layer film as described in JP2011-053705A can be used.

In addition, the λ/4 retardation plate is not limited. Accordingly, various known λ/4 retardation plates such as a stretched polycarbonate film, a stretched norbornene-based polymer film, a transparent film containing and aligning inorganic particles having birefringence such as strontium carbonate, a thin film obtained by obliquely depositing an inorganic dielectric on a support, a film obtained by uniaxially aligning and fixing a polymerizable liquid crystal compound, and a film obtained by uniaxially aligning and fixing a liquid crystal compound can be used as the λ/4 retardation plate.

In the image display device 200 shown in FIG. 16, a first partial reflection element 211 and a second partial reflection element 213 are disposed in this order on a surface side of the circular polarization plate 204 opposite to the image display element 202. The first partial reflection element 211 and the second partial reflection element 213 constitute an optical unit 210. The optical unit 210 can increase the optical path length in a limited space by reciprocating light between the first partial reflection element 211 and the second partial reflection element 213, and thus contributes to the reduction in size of the image display unit.

In the image display device 200, any one of the first partial reflection element 211 or the second partial reflection element 213 is a liquid crystal diffraction element including the cholesteric liquid crystal layer according to the embodiment of the present invention. The liquid crystal diffraction element (partial reflection element) including the cholesteric liquid crystal layer has an action of reflecting one circularly polarized light of incidence light, transmitting the other circularly polarized light, and diffracting the reflected light. Therefore, the liquid crystal diffraction element can act as a concave mirror in a flat shape, and thus the optical device (image display device) can be made thinner.

For example, in the example shown in FIG. 16, the first partial reflection element 211 is the liquid crystal diffraction element according to the embodiment of the present invention, and the second partial reflection element 213 is a partial reflection element having no diffraction action (lens action) such as a general half mirror.

In this case, as shown in FIG. 16, light emitted from the image display element 202 and transmitted through the circular polarization plate 204 is transmitted through the first partial reflection element 211 and reaches the second partial reflection element 213. The second partial reflection element 213 reflects a part of light to the first partial reflection element 211 side. The first partial reflection element 211 reflects the light reflected by the second partial reflection element 213 to the second partial reflection element 213 side. In this case, the first partial reflection element 211 acts as a concave mirror, and diffracts (bends) light at a larger angle toward the end part side such that the reflected light is collected. A part of the light reflected by the first partial reflection element 211 is transmitted through the second partial reflection element 213 and is visually recognized by the user U as an image.

As shown in FIG. 16, the first partial reflection element 211 acts as a concave mirror, and thus diffracts (bends) light more toward the end part side than the center region. In the partial reflection element in the related art, as the diffraction angle increases, the diffraction efficiency decreases. Therefore, there is a problem in that the brightness of the image displayed by the image display device is high at the center portion and decreases toward the end part, and the brightness unevenness in-plane increases.

On the other hand, in the image display device 200 shown in FIG. 16, since the cholesteric liquid crystal layer provided in one partial reflection element has the above-described configuration, the one period ∧ of the liquid crystal alignment pattern is short, and the diffraction efficiency can be increased even at the end part having a large diffraction angle, and the diffraction efficiency in-plane can be made more uniform. As a result, the brightness unevenness of the displayed image can be reduced.

In each of the above-described examples, one partial reflection element is a liquid crystal diffraction element that acts as a concave mirror, and the other partial reflection element is a half mirror that does not have a general lens action. However, the present invention is not limited to this, and the other partial reflection element may act as a concave mirror or may act as a convex mirror. In addition, in a case where the other partial reflection element consisting of a half mirror, a reflective volume hologram, or the like acts as a concave mirror, one partial reflection element consisting of a liquid crystal diffraction element may act as a convex mirror.

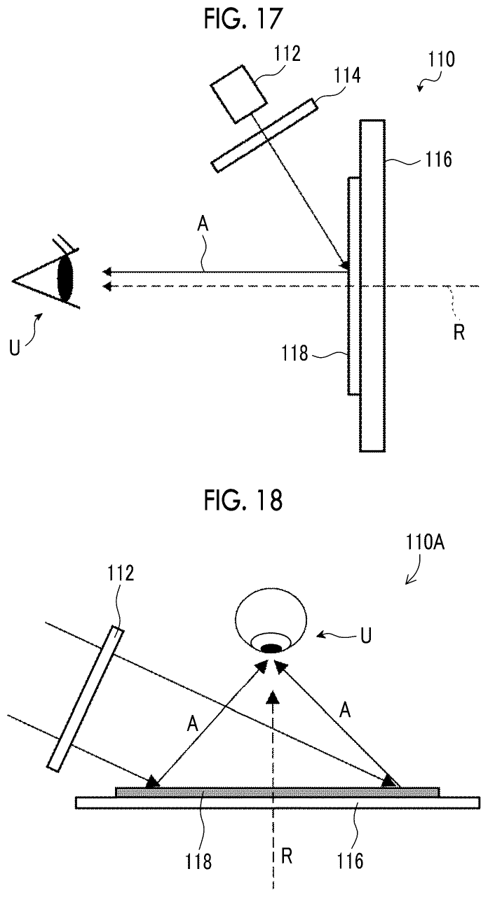

FIG. 17 conceptually shows another example of the image display device including the optical device according to the embodiment of the present invention.

An image display device 110 shown in FIG. 17 includes an image projection element 112, a retardation plate 114, a transparent substrate 116, and a liquid crystal diffraction element 118 according to the embodiment of the present invention.

The image display device shown in FIG. 17 is an image display device that displays augmented reality in which a virtual image A is superimposed on a real scene R.

The image display device 110 in the example shown in the drawing is, for example, AR glasses. FIG. 17 is a view of the image display device 110 as viewed from above (the top side of the top and bottom) in a state where a user U wears the AR glasses.

In the image display device 110, the image projection element 112 is mounted on a temple of the AR glasses, for example.

In the image display device 110, the image projection element 112 projects (displays) the virtual image A. In other words, the image projection element 112 projects an image that is the virtual image A.

The image projection element 112 is not limited, and various well-known projection elements (display elements, projectors) used for AR glasses or the like can be used.

Examples of the image projection element 112 include a laser light source, a scanning projection element that two-dimensionally scans a light beam modulated according to an image using a spatial light modulator (SLM), and a well-known display exemplified as the image display element 202.

As the spatial light modulator, for example, a micro electro mechanical systems (MEMS) type spatial light modulator, an optical element (PLZT element) that modulates transmitted light using an electro-optic effect, a liquid crystal shutter array such as a liquid crystal shutter (FLC), and a well-known light deflection element can be used. The spatial light modulator may be of a reflective type or a transmissive type.

The MEMS type spatial light modulator means a spatial light modulator driven by an electromechanical operation using an electrostatic force, and for example, a well-known MEMS (light) scanner, a MEMS light deflector, a MEMS mirror, and a digital micromirror device (DMD) that deflect (deflection scan) light by swinging a mirror (a mirror) using a piezoelectric actuator or the like, such as a MEMS light deflection element described in JP2012-208352A, a MEMS light deflection element described in JP2014-134642A, and a MEMS light deflection element described in JP2015-22064A, can be used.

The retardation plate 114 converts the virtual image A of linearly polarized light projected by the image projection element 112 into the virtual image A of predetermined circularly polarized light corresponding to the liquid crystal diffraction element 118.

In the image display device 110 in the example shown in the drawing, the retardation plate 114 converts the virtual image A of linearly polarized light into the virtual image A of right circularly polarized light, for example.

The retardation plate 114 is preferably a λ/4 plate (¼ wavelength plate). By using the λ/4 plate as the retardation plate 114, the virtual image A of linearly polarized light can be suitably converted into the virtual image A of right circularly polarized light, and the utilization efficiency of the virtual image A projected by the image projection element 112 can be improved.

As the retardation plate 114, a well-known retardation plate can be used, and a λ/4 retardation plate constituting the circular polarization plate can be used.

It is also preferable that the retardation plate 114 is a retardation plate obtained by laminating a plurality of retardation plates to effectively exhibit a desired action. In a case where the retardation plate 114 is a λ/4 plate, it is also preferable that a retardation plate obtained by laminating a plurality of retardation plates to function as a λ/4 plate is used. For example, a broadband λ/4 plate described in WO2013/137464A, in which a λ/2 plate and a λ/4 plate are used in combination, can handle with incidence light in a wide wavelength range and can be preferably used.

Further, it is preferable that the retardation plate 114 has reverse wavelength dispersibility. In a case where the retardation plate 114 has reverse wavelength dispersibility, the retardation plate 114 can correspond to incidence light having a wide wavelength range.

The retardation plate 114 is disposed by adjusting the direction of the slow axis such that the linearly polarized light is converted into circularly polarized light in a desired revolution direction according to the polarization direction of the linearly polarized light of the image projected by the image projection element 112.

The transparent substrate 116 is not limited, and a base material consisting of various well-known materials can be used as long as the base material has sufficient transparency for observing the real scene R and can support the liquid crystal diffraction element 118. Examples of the transparent substrate 116 include the transparent support of the substrate 32. In addition, the transparent substrate 116 may be an eyeglass lens of AR glasses.

In the image display device 110, the real scene R is transmitted through the transparent substrate 116 and the liquid crystal diffraction element 118 and is observed by the user U.

On the other hand, the virtual image A (projected image) projected by the image projection element 112 is converted into predetermined circularly polarized light by the retardation plate 114, is diffracted by the liquid crystal diffraction element 118, and is reflected toward the user U to be observed by the user U.

As a result, the user U of the image display device 110 can observe the augmented reality in which the virtual image A is superimposed on the real scene R.

More specifically, in a case where the image projection element 112 of the image display device 110 projects an image of linearly polarized light of green light as the virtual image A (image that is the virtual image A), the virtual image A of the linearly polarized light projected by the image projection element 112 is converted into right circularly polarized light by the retardation plate 114.

The virtual image A of the right circularly polarized light converted by the retardation plate 114 is irradiated to the observation position of the user U by the cholesteric liquid crystal layer of the liquid crystal diffraction element 118 that acts as a concave mirror.

On the other hand, in the image display device 110, the real scene R is transmitted through the transparent substrate 116, is transmitted through the liquid crystal diffraction element 118, and is observed by the user U. As a result, the user U of the image display device 110 can observe the augmented reality in which the virtual image A is superimposed on the real scene R.

In a case where the cholesteric liquid crystal layer of the liquid crystal diffraction element 118 is a reflective type polarization diffraction element that reflects only right circularly polarized light of green light and transmits the other light, in the real scene R, only the right circularly polarized light of green light is reflected by the liquid crystal diffraction element 118, and the other light is transmitted through the liquid crystal diffraction element 118 to reach the observation position of the user U.

In addition, in a case where the liquid crystal diffraction element 118 includes three cholesteric liquid crystal layers that reflect light corresponding to red light, green light, and blue light, respectively, circularly polarized light having a direction of revolution opposite to circularly polarized light reflected by each cholesteric liquid crystal layer is transmitted through the liquid crystal diffraction element 118.

Accordingly, with the image display device 110, the user U can observe the augmented reality in which the virtual image A is superimposed on the bright real scene R.

In the image display device 110, since the cholesteric liquid crystal layer of the liquid crystal diffraction element 118 has the above-described configuration, the one period ∧ of the liquid crystal alignment pattern is short, and the diffraction efficiency of the reflected light can be increased even at the end part of the liquid crystal diffraction element 118 having a large diffraction angle, so that the diffraction efficiency in-plane can be made more uniform. As a result, the brightness unevenness of the virtual image A observed by the user U can be reduced.

FIGS. 18 to 20 conceptually show other examples of the image display device including the optical device according to the embodiment of the present invention.

In FIGS. 18 to 20, the same members as the members shown in FIG. 17 are denoted by the same reference numerals. Since the members denoted by the same reference numerals also have the same functions, the description thereof will be omitted.

An image display device 110A shown in FIG. 18 includes an image projection element 112, a transparent substrate 116, and the liquid crystal diffraction element 118 according to the embodiment of the present invention. The image projection element 112 shown in FIG. 18 is a spatial light modulator (SLM) that converts a light beam.

As indicated by an arrow in FIG. 18, the virtual image A projected by the image projection element 112 is reflected by the cholesteric liquid crystal layer (not shown) of the liquid crystal diffraction element 118 and is emitted to the observation position of the user U.

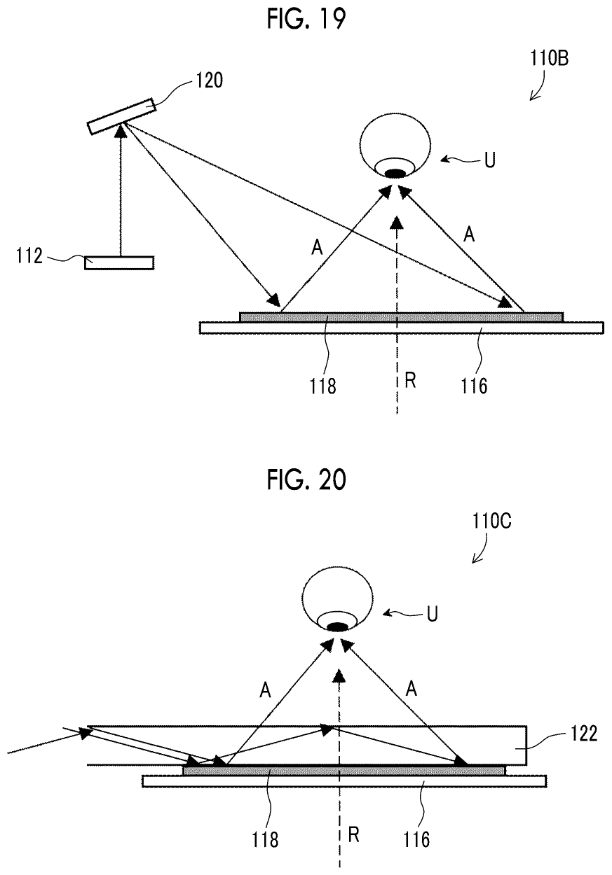

An image display device 110B shown in FIG. 19 includes the image projection element 112, a MEMS mirror 120, the transparent substrate 116, and the liquid crystal diffraction element 118 according to the embodiment of the present invention.

The MEMS mirror 120 is a MEMS type spatial light modulator that deflects (deflection-scans) light by swinging a mirror using a piezoelectric actuator.

As indicated by an arrow in FIG. 19, the virtual image A projected by the image projection element 112 is reflected by the MEMS mirror 120, is reflected by the cholesteric liquid crystal layer (not shown) of the liquid crystal diffraction element 118, and is emitted to the observation position of the user U.

An image display device 110C shown in FIG. 20 includes a light guide plate 122, the transparent substrate 116, and the liquid crystal diffraction element 118 according to the embodiment of the present invention.

The light guide plate 122 is a member having a function of propagating light (virtual image) emitted from an image projection element (not shown) in the light guide plate 122. The liquid crystal diffraction element 118 is disposed on a surface of the light guide plate 122 opposite to the user U side.

In the image display device 110C shown in FIG. 20, as indicated by an arrow, the virtual image A projected by the image projection element (not shown) propagates in the light guide plate 122, is reflected by the cholesteric liquid crystal layer (not shown) of the liquid crystal diffraction element 118, and is emitted to the observation position of the user U.

In all of the image display devices shown in FIGS. 18 to 20, the cholesteric liquid crystal layer of the liquid crystal diffraction element 118 has the above-described predetermined liquid crystal alignment pattern. As a result, as indicated by an arrow in each drawing, the virtual image A projected by the image projection element can be appropriately emitted to the observation position of the user U over the entire surface of the polarization diffraction element, and the diffraction efficiency of the reflected light can be increased even at the end part of the liquid crystal diffraction element where the one period ∧ of the liquid crystal alignment pattern is short and the diffraction angle is large, so that the diffraction efficiency in-plane can be made more uniform.

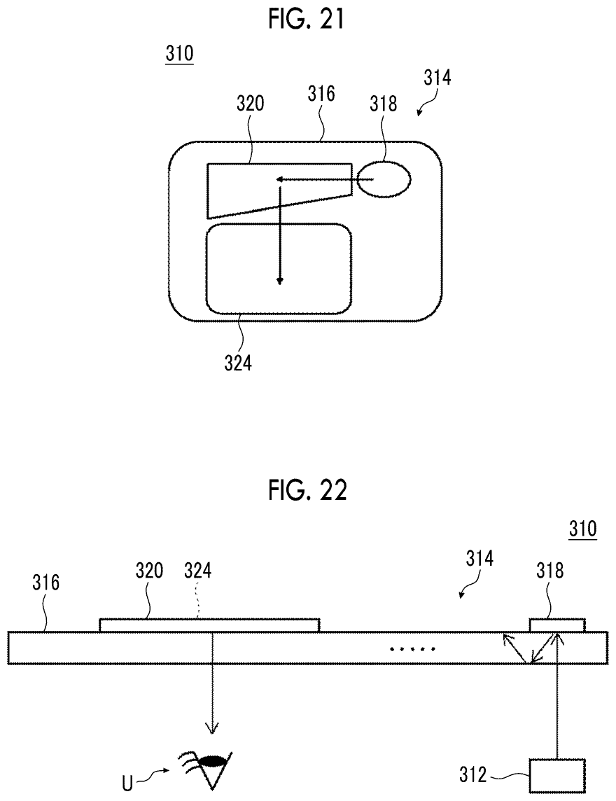

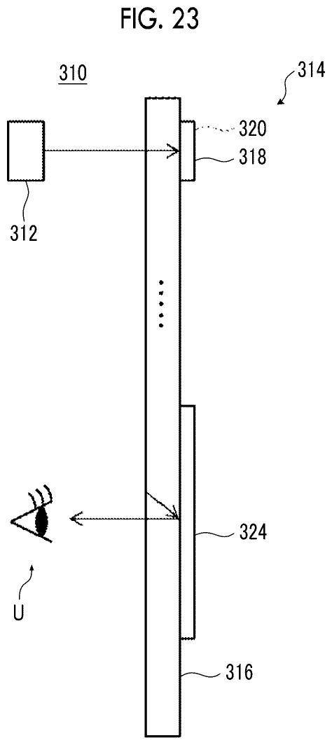

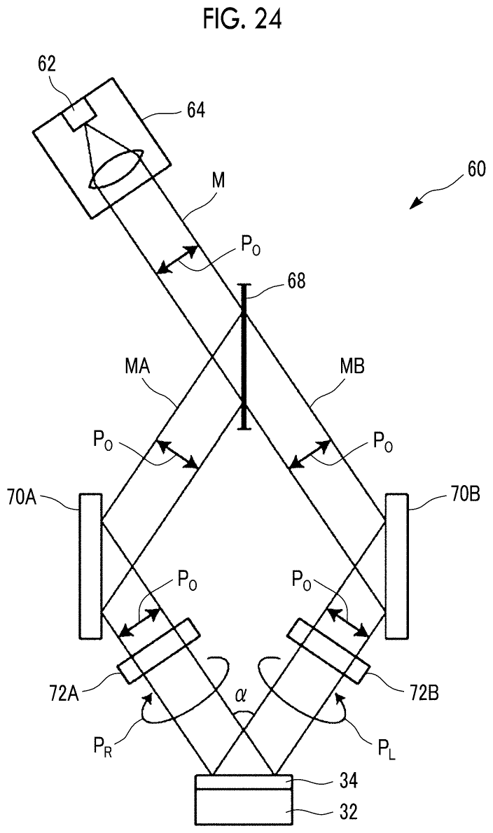

FIGS. 21 to 23 conceptually show other examples of the image display device including the optical device according to the embodiment of the present invention.

An image display device 310 shown in FIGS. 21 to 23 includes a display element 312 and a light guide element 314. The light guide element 314 includes a light guide plate 316, and an incidence diffraction element 318, an intermediate diffraction element 320, and an exit diffraction element 324 that are provided in the light guide plate 316. At least one of the incidence diffraction element 318, the intermediate diffraction element 320, or the exit diffraction element 324 included in the image display device 310 is the liquid crystal diffraction element according to the embodiment of the present invention. In FIG. 21, the display element 312 is not shown.

In the image display device 310 shown in FIGS. 21 to 23, the incidence diffraction element 318, the intermediate diffraction element 320, and the exit diffraction element 324 are disposed at different positions in the plane direction of the main surface of the light guide plate 316. In the example shown in FIG. 21, the intermediate diffraction element 320 is disposed on the left side of FIG. 21 of the incidence diffraction element 318, and the exit diffraction element 324 is disposed on the lower side of FIG. 21 of the intermediate diffraction element 320.

In the image display device 310, the image (light corresponding to the image) displayed by the display element 312 is diffracted by the incidence diffraction element 318 and is incident into the light guide plate 316. In this case, the incidence diffraction element 318 diffracts the light such that the traveling direction of the diffracted light is directed toward the intermediate diffraction element 320. In the example shown in FIG. 21, the incidence diffraction element 318 diffracts the incident light in the left direction in FIG. 21.

The diffracted light by the incidence diffraction element 318 is totally reflected and propagates in the light guide plate 316, and is incident into the intermediate diffraction element 320. The intermediate diffraction element 320 diffracts the light such that the traveling direction of the incident light is directed toward the exit diffraction element 324. In the example shown in FIG. 21, the intermediate diffraction element 320 diffracts the incident light in the downward direction in FIG. 21.

The light diffracted by the intermediate diffraction element 320 is totally reflected and propagates in the light guide plate 316, and is incident into the exit diffraction element 324. The exit diffraction element 324 diffracts the incident light to deviate from the angle at which total reflection occurs in the light guide plate 316. In the example shown in FIG. 21, the exit diffraction element 324 diffracts the incident light in a direction perpendicular to the paper surface in FIG. 21. That is, as shown in FIG. 22, the exit diffraction element 324 diffracts the incident light in a direction substantially perpendicular to the main surface of the light guide plate 316.

The light diffracted by the exit diffraction element 324 is emitted from the light guide plate 316 to the user U. As a result, the image display device 310 can display the image emitted from the display element 312.

Since the light guide element 314 includes the intermediate diffraction element 320, in a case where the light is diffracted by the intermediate diffraction element 320, the exit pupil can be enlarged by diffracting a part of the light at a plurality of locations of the intermediate diffraction element.

In the image display device 310 shown in FIGS. 21 to 23, at least one (preferably, all) of the incidence diffraction element 318, the intermediate diffraction element 320, or the exit diffraction element 324 is the liquid crystal diffraction element according to the embodiment of the present invention, and the cholesteric liquid crystal layer having the above-described configuration is provided. As a result, the reflected light can be diffracted in an appropriate direction, and the diffraction efficiency of the reflected light can be increased even at the end part of the diffraction element having a short one period ∧ and a large diffraction angle of the liquid crystal alignment pattern, and the diffraction efficiency of the diffraction element in-plane can be made more uniform.

Hereinbefore, the liquid crystal diffraction element and the optical device according to the embodiments of the present invention have been described in detail, but the present invention is not limited to the above-described examples, and various improvements or modifications may be made within a range not departing from the scope of the present invention.

### EXAMPLES

The features of the present invention will be described in more detail with reference to the following examples.

The materials, the reagents, the amounts, the amounts of materials, the proportions, the treatment details, the treatment procedures, and the like shown in Examples below can be appropriately modified within a range not departing from the spirit of the present invention. Therefore, the scope of the present invention should not be construed as being limited by the specific examples described below.

### Comparative Example 1

### <Production of Liquid Crystal Diffraction Element>

### (Support)

A glass substrate was used as the support.

### (Formation of Alignment Film)

The following coating liquid for forming an alignment film was applied to a support by spin coating. The support on which the coating film of the alignment film-forming coating liquid was formed was dried using a hot plate at 60° C. for 60 seconds. As a result, an alignment film was formed.

### Coating Liquid for Forming Alignment Film

| | |
|---|---|
| Material A for photo-alignment | 1.00 part by mass |
| Water | 16.00 parts by mass |
| Butoxyethanol | 42.00 parts by mass |
| Propylene glycol monomethyl ether | 42.00 parts by mass |

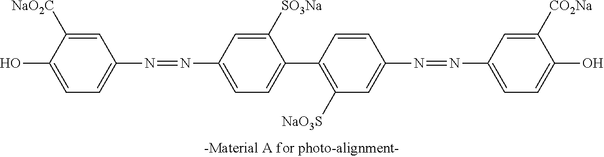

### (Exposure of Alignment Film)

The alignment film was exposed using the exposure device shown in FIG. 15 to form an alignment film P-1 having a concentric circular alignment pattern.

In the exposure device, a laser which emits laser beam having a wavelength (355 nm) was used as the laser. The exposure amount of the interference light was 1000 mJ/cm².

### (Formation of Cholesteric Liquid Crystal Layer)

As a liquid crystal composition for forming the cholesteric liquid crystal layer G1, the following composition G-1 was prepared.

### Composition G-1

| | | |
|---|---|---|
| Rod-like liquid crystal compound L-1 | 90.00 | parts by mass |
| Rod-like liquid crystal compound L-2 | 10.00 | parts by mass |
| Polymerization initiator (manufactured by | 3.00 | parts by mass |
| BASF SE, Omnirad (registered trademark) | | |
| Chiral agent Ch-1 | 5.20 | parts by mass |
| Leveling agent T-1 | 0.20 | parts by mass |
| Methyl ethyl ketone | 126.7 | parts by mass |
| Cyclopentanone | 126.7 | parts by mass |

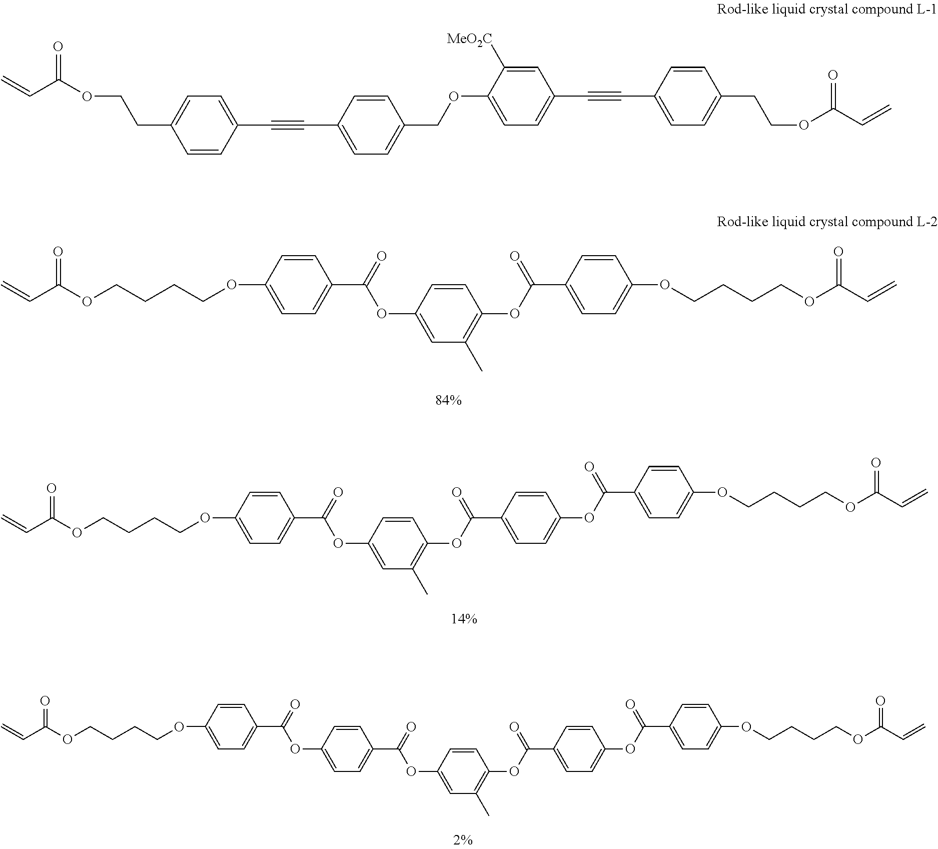

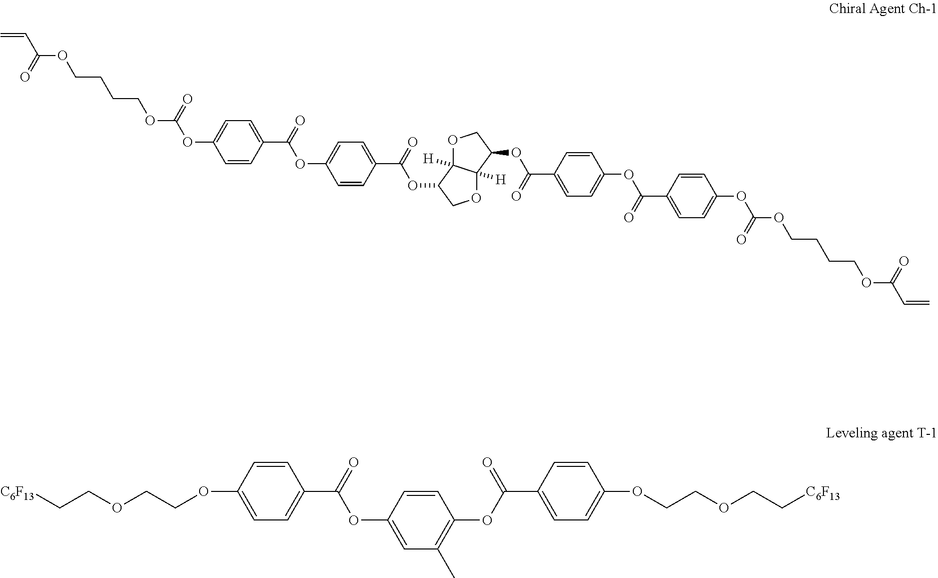

The cholesteric liquid crystal layer G1 was formed by applying multiple layers of the composition G-1 to the photo-alignment film. The application in multiple layers refers to repetition of processes including producing a first liquid crystal fixed layer by applying the first layer-forming composition G-1 onto the alignment film, heating the composition G-1, and irradiating the composition G-1 with ultraviolet light for curing; and producing a second or subsequent liquid crystal fixed layer by applying the second or subsequent layer-forming composition G-1 onto the formed liquid crystal fixed layer, heating the composition G-1, and irradiating the composition G-1 with ultraviolet light for curing as described above.

First, the composition G-1 was applied to the alignment film P-1 by spin coating, and the coating film was heated on a hot plate at 90° C. for 120 seconds. Thereafter, the coating film was irradiated with ultraviolet rays having a wavelength of 365 nm at an irradiation dose of 300 mJ/cm² using a high-pressure mercury lamp on a hot plate at 90° C. in a nitrogen atmosphere, thereby fixing the alignment of the liquid crystal compound. For the second and subsequent layers, the composition G-1 was applied to the previously prepared liquid crystal fixed layer by overcoating, and the composition G-1 was heated and then cured with ultraviolet rays under the same conditions as those for the first layer to prepare a liquid crystal fixed layer. In this manner, the overcoating was repeated until the total thickness reached a desired film thickness, thereby forming the cholesteric liquid crystal layer G1 (reflective type liquid crystal diffraction element G1).

It was verified using a polarizing microscope that the cholesteric liquid crystal layer G1 had a periodic alignment pattern as shown in FIG. 5. In a case where a cross section of the coating layer was verified using an SEM, in the liquid crystal alignment pattern of the cholesteric liquid crystal layer G1, the one period ∧ over which the optical axis of the liquid crystal compound rotated by 180° was a liquid crystal alignment pattern in which the one period at a distance of 2.5 mm from the center was 5.3 μm and the one period at a distance of 20 mm from the center was 0.8 μm, and the one period decreased toward the outer direction.

Further, in the obtained cholesteric liquid crystal layer G1, the tilt angle of the liquid crystal compound was 0° at a distance of 2.5 mm from the center and the tilt angle was 0° at a distance of 20 mm from the center.

In addition, the length of the single pitch (helical pitch P) of the helical structure in the cholesteric liquid crystal layer G1 was 327 nm.

In addition, the direction D_{R} in which the retardation Re was minimized in the cholesteric liquid crystal layer G1 at a distance of 2.5 mm from the center and a distance of 20 mm from the center was measured using the above-described method. As a result, at a distance of 2.5 mm from the center and a distance of 20 mm from the center, in the cholesteric liquid crystal layer G1, the direction D_{R} in which the retardation was minimized was not tilted with respect to the normal direction of the main surface of the cholesteric liquid crystal layer. Accordingly, in the cholesteric liquid crystal layer G1, the direction D_{R} in which the retardation was minimized was the same in-plane.

### Example 1

### <Production of Liquid Crystal Diffraction Element>

### (Formation of Alignment Film)

An alignment film was formed on the support in the same manner as in Comparative Example 1.

### (Exposure of Alignment Film)

The formed alignment film was irradiated with unpolarized ultraviolet rays having a wavelength of 365 nm using an LED-UV exposure machine.

In this case, the coating film was irradiated with ultraviolet rays while changing the irradiation amount and the irradiation angle of the ultraviolet rays in-plane. Specifically, the alignment film was irradiated while changing the irradiation amount in-plane such that the irradiation amount increased from the center toward the outer side. In addition, in a case where the normal direction of the glass substrate was regarded as 0° and the plane direction of the glass substrate was regarded as 90°, the alignment film was irradiated while changing the irradiation angle in-plane such that the irradiation angle decreased from the center toward the outer side.

The irradiation of the alignment film with the unpolarized ultraviolet rays was carried out in a concentric circular shape.

Next, the alignment film was exposed in the same manner as in Comparative Example 1 using the exposure device shown in FIG. 15 to form an alignment film P-2 having a concentric circular alignment pattern.

### (Formation of Cholesteric Liquid Crystal Layer)

As a liquid crystal composition for forming a cholesteric liquid crystal layer G2, the following composition G-2 was prepared.

### Composition G-2

| | | |
|---|---|---|
| Rod-like liquid crystal compound L-1 | 90.00 | parts by mass |
| Rod-like liquid crystal compound L-2 | 10.00 | parts by mass |
| Polymerization initiator (manufactured by | 3.00 | parts by mass |
| BASF SE, Omnirad (registered trademark) | | |
| Chiral agent Ch-1 | 5.20 | parts by mass |
| Leveling agent T-2 | 0.03 | parts by mass |
| Leveling agent T-3 | 0.10 | parts by mass |
| Methyl ethyl ketone | 126.7 | parts by mass |
| Cyclopentanone | 126.7 | parts by mass |

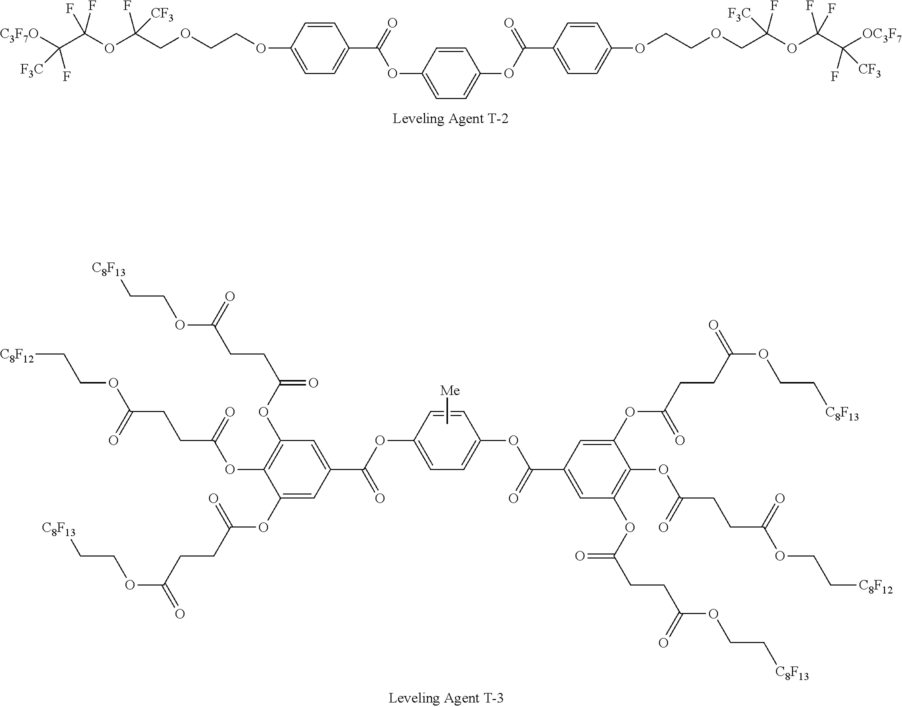

A cholesteric liquid crystal layer G2 was formed by applying the composition G-2 to the alignment film. Specifically, the composition G-2 was applied to the alignment film P-2 by spin coating, and the coating film was heated on a hot plate at 90° C. for 120 seconds. Thereafter, the coating film was irradiated with ultraviolet light having a wavelength of 365 nm at an irradiation dose of 300 mJ/cm² using a high-pressure mercury lamp in a nitrogen atmosphere on a hot plate at 90° C. to fix the alignment of the liquid crystal compound, thereby forming a cholesteric liquid crystal layer G2 (reflective type liquid crystal diffraction element G2).

It was verified using a polarizing microscope that the cholesteric liquid crystal layer G2 had a periodic alignment pattern as shown in FIG. 5. In a case where a cross section of the coating layer was verified using an SEM, in the liquid crystal alignment pattern of the cholesteric liquid crystal layer G2, regarding the one period ∧ over which the optical axis of the liquid crystal compound rotated by 180°, the one period at a position of 2.5 mm away from the center of the liquid crystal alignment pattern was 5.3 μm, and the one period at a position of 20 mm away from the center of the liquid crystal alignment pattern was 0.8 μm, and the liquid crystal alignment pattern was a liquid crystal alignment pattern where the one period decreased toward the outer direction.

Further, in the cholesteric liquid crystal layer G2, the tilt angle of the liquid crystal compound was 2° at a position of 2.5 mm away from the center of the liquid crystal alignment pattern, and the tilt angle was 12° at a position of 20 mm away from the center of the liquid crystal alignment pattern.

In addition, the length of the single pitch (helical pitch P) in the cholesteric liquid crystal layer G2 was 327 nm.

In addition, as a result of measuring the direction D_{R} of the cholesteric liquid crystal layer G2 using the above-described method, the angle θ2 between the direction D_{R} and the normal direction of the main surface of the cholesteric liquid crystal layer G2 was 2° at a position of 2.5 mm away from the center of the liquid crystal alignment pattern, and the angle θ2 was 12° at a position of 20 mm away from the center of the liquid crystal alignment pattern. Accordingly, in the cholesteric liquid crystal layer G2, the direction D_{R} in which the retardation was minimum varied in-plane.

### [Evaluation]

In a case where light was incident into the produced optical element from the front (direction with an angle of 0° with respect to the normal line), intensity of emitted light was evaluated.

Specifically, laser light having an output central wavelength of 532 nm was emitted from the light source to be vertically incident into the prepared liquid crystal diffraction element. The laser light was made to be circularly polarized by being perpendicularly incident into a circular polarization plate corresponding to the wavelength of the laser light, and then the circularly polarized light was incident into the produced liquid crystal diffraction element.

Among the emitted light from the liquid crystal diffraction element, the intensities of diffracted light (first-order light) diffracted in a desired direction from the liquid crystal diffraction element and zero-order light (emitted in the same one direction as the incidence light) emitted in another direction were measured with a photodetector.

The intensity of diffracted light of the first-order light was evaluated by the following expression.

Intensity of diffracted light=First-order light/(First-order light+Zero-order light)

In the liquid crystal diffraction elements produced in Comparative Example 1 and Example 1, the intensities of diffracted light of the first-order light at a wavelength of 532 nm at the position of 2.5 mm away from the center were substantially the same.

On the other hand, at the position of 20 mm away from the center, the liquid crystal diffraction element according to Example 1 was improved in the intensity of diffracted light of the first-order light at a wavelength of 532 nm as compared with the liquid crystal diffraction element according to Comparative Example 1.

### Comparative Example 2

### <Production of Liquid Crystal Diffraction Element>

### (Formation of Alignment Film)

An alignment film was formed on a support using the same method as that of Comparative Example 1.

### (Exposure of Alignment Film)

The alignment film was exposed using the exposure device illustrated in FIG. 24 to form an alignment film P-3 having an alignment pattern.

An exposure device 60 shown in FIG. 24 includes: a light source 64 that includes a laser 62 and a λ/2 plate (not shown); a polarization beam splitter 68 that splits laser light M emitted from the light source 64 into two beams MA and MB; mirrors 70A and 70B that are disposed on optical paths of the split two beams MA and MB; and λ/4 plates 72A and 72B. The polarization direction of the laser light M emitted from the laser 62 was changed by the λ/2 plate, and the laser light M was emitted from the light source 64 as linearly polarized light P₀. The 24 plates 72A and 72B had optical axes parallel to each other. The λ/4 plate 72A converted the linearly polarized light P₀ (ray MA) into right circularly polarized light PR, and the λ/4 plate 72B converted the linearly polarized light P₀ (ray MB) into left circularly polarized light P_{L}.

The substrate 32 including the alignment film 34 before the alignment pattern was formed was disposed at the exposed portion, the two rays MA and MB were caused to intersect with each other on the alignment film 34 to cause interference, and the alignment film 34 was irradiated with and exposed to the interference light to obtain an alignment film having an alignment pattern in which the alignment state periodically changed.

In the exposure device 60, a laser that emits laser light having a wavelength (355 nm) was used as the laser 62. The exposure amount of the interference light was 1000 mJ/cm². In addition, the one period (the length over which the optical axis rotates by 180°) of the alignment pattern formed in the alignment film 34 by the interference of the two laser beams was controlled by changing the intersecting angle α between the two rays MA and MB.

### (Formation of Cholesteric Liquid Crystal Layer)

A cholesteric liquid crystal layer (G3) was formed using the same method as that of Comparative Example 1, except that the above-described alignment film P-3 was used.

It was verified using a polarizing microscope that the cholesteric liquid crystal layer G3 had a periodic alignment pattern as shown in FIG. 5. In a case where a cross section of the coating layer was verified using an SEM, in the liquid crystal alignment pattern of the cholesteric liquid crystal layer G3, the one period ∧ over which the optical axis of the liquid crystal compound rotated by 180° was 0.44 μm.

Further, in the cholesteric liquid crystal layer G3, the tilt angle of the liquid crystal compound was 0° at a position at a distance of 5 mm from the left end and the tilt angle of the liquid crystal compound was 0° at a position at a distance of 20 mm from the left end.

In addition, the length of the single pitch (helical pitch P) in the cholesteric liquid crystal layer G3 was 327 nm.

In addition, the direction D_{R} of the cholesteric liquid crystal layer G3 at a position at a distance of 5 mm from the left end and a position at a distance of 20 mm from the left end was measured using the above-described method. As a result, at the position at a distance of 5 mm from the left end and the position at a distance of 20 mm from the left end, in the cholesteric liquid crystal layer G3, the direction D_{R} in which the retardation was minimum was not tilted with respect to the normal direction of the main surface of the cholesteric liquid crystal layer. Accordingly, in the cholesteric liquid crystal layer G3, the direction D_{R} in which the retardation was minimized was the same in-plane.

### Example 2

### <Production of Liquid Crystal Diffraction Element>

### (Formation of Alignment Film)

An alignment film was formed on a support using the same method as that of Comparative Example 1.

### (Exposure of Alignment Film)

The formed alignment film was irradiated with unpolarized ultraviolet rays having a wavelength of 365 nm using an LED-UV exposure machine.

In this case, the coating film was irradiated with ultraviolet rays while changing the irradiation amount and the irradiation angle of the ultraviolet rays in-plane. Specifically, the alignment film was irradiated by changing the irradiation amount in-plane such that the irradiation amount increased from the left side to the right side of the alignment film. In addition, in a case where the normal direction of the glass substrate was set to 0° and the plane direction of the glass substrate was set to 90°, the alignment film was irradiated by changing the irradiation angle in-plane such that the irradiation angle decreased from the left side to the right side of the alignment film.

Next, using the same method as that of Comparative Example 2, the alignment film was exposed using the exposure device shown in FIG. 24 to form an alignment film P-4 having an alignment pattern.

### (Formation of Cholesteric Liquid Crystal Layer)

A cholesteric liquid crystal layer (G4) was formed using the same method as that of Example 1, except that the above-described alignment film P-4 was used.

It was verified using a polarizing microscope that the cholesteric liquid crystal layer G4 had a periodic alignment pattern as shown in FIG. 5. In a case where a cross section of the coating layer was verified using an SEM, in the liquid crystal alignment pattern of the cholesteric liquid crystal layer G4, the one period ∧ over which the optical axis of the liquid crystal compound rotated by 180° was 0.44 μm.

Further, in the cholesteric liquid crystal layer G4, the tilt angle of the liquid crystal compound was 2° at a position at a distance of 5 mm from the left end of the liquid crystal alignment pattern, and the tilt angle was 22° at a position at a distance of 20 mm from the left end of the liquid crystal alignment pattern.

In addition, the length of the single pitch (helical pitch P) in the cholesteric liquid crystal layer G4 was 327 nm.

In addition, as a result of measuring the direction D_{R} of the cholesteric liquid crystal layer G4 using the above-described method, the angle θ2 between the direction D_{R} and the normal direction of the main surface of the cholesteric liquid crystal layer G4 was 2° at a position at a distance of 5 mm from the left end of the liquid crystal alignment pattern, and the angle θ2 was 22° at a position at a distance of 20 mm from the left end of the liquid crystal alignment pattern. Accordingly, in the cholesteric liquid crystal layer G4, the in-plane directions D_{R} in which the retardation was minimum were different from each other.

### [Evaluation]

The intensity of emitted light of the liquid crystal diffraction element produced in each example was measured using the following method.

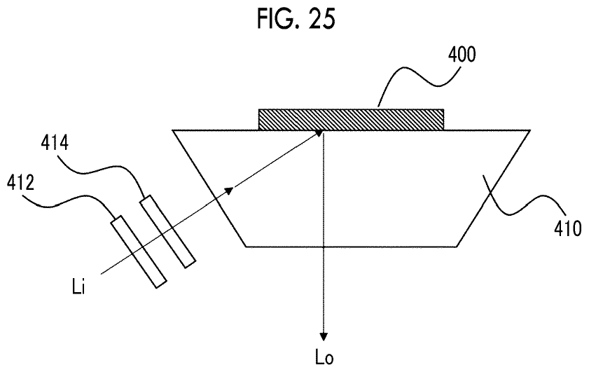

As shown in FIG. 25, a liquid crystal diffraction element 400 was disposed on the surface of a dove prism 410. As the dove prism 410, a dove prism made of glass having a refractive index of 1.5 was used. In addition, the glass substrate was peeled off from the liquid crystal diffraction element produced in each example, and the obtained cholesteric liquid crystal layer and the dove prism were bonded to each other using a thermosensitive adhesive.

As shown in FIG. 25, the liquid crystal diffraction element 400 was disposed on the upper surface of the dove prism 410, a laser (not shown) was disposed at a position facing the inclined surface of the dove prism 410, and a linear polarizer 412 and a λ/4 plate 414 were disposed between the laser and the dove prism 410.

Laser light Li emitted from the laser was incident into the dove prism 410 as circularly polarized light by passing through the linear polarizer 412 and the λ/4 plate 414, was propagated in the dove prism 410, and was incident into the cholesteric liquid crystal layer of the liquid crystal diffraction element 400. The diffracted light reflected and diffracted by the cholesteric liquid crystal layer was propagated in the dove prism 410 in a direction opposite to the surface on which the cholesteric liquid crystal layer was disposed. The light propagated in the dove prism 410 reached the lower surface of the dove prism 410 and was emitted as emitted light Lo.

In a case where the position of the left end of the cholesteric liquid crystal layer was set to 0 mm, the laser light Li was incident into each of the positions of 5 mm and 20 mm of the cholesteric liquid crystal layer, and the intensity of emitted light Lo at each position was measured. The wavelength of the laser light Li was 532 nm, and the incidence angle of the laser light Li was set to 54° such that light was incident into the cholesteric liquid crystal layer at 54° with respect to the normal direction of the cholesteric liquid crystal layer. The intensity of emitted light Lo that was reflected and diffracted by the cholesteric liquid crystal layer and was emitted in the normal direction of the main surface of the cholesteric liquid crystal layer (normal direction of the lower surface of the dove prism 410) was measured.

In a case where the intensity of the laser light Li incident into the dove prism 410 is denoted by Iᵢₙ and the intensity of diffracted light (first-order light, emitted light Lo) diffracted by the cholesteric liquid crystal layer and diffracted in a desired direction from the dove prism 410 is denoted by Iₒᵤₜ, the diffraction efficiency Deff of the prepared cholesteric liquid crystal layer was calculated by the following expression.

$$Diffraction efficiency Deff = {I}_{out} / {I}_{i n}$$

In a case where the diffraction efficiency was calculated, the diffraction efficiency was calculated except for a loss of the transmittance at the interface during the incidence and emission of the light into and from the dove prism 410.

In the liquid crystal diffraction elements prepared in Comparative Example 2 and Example 2, the diffraction efficiencies of first-order light at a wavelength of 532 nm were substantially the same at the position of 5 mm from the left end of the liquid crystal alignment pattern.

On the other hand, at the position of 20 mm from the left end of the liquid crystal alignment pattern, the diffraction efficiency of first-order light at a wavelength of 532 nm of the liquid crystal diffraction element according to Example 2 was improved as compared with the liquid crystal diffraction element according to Comparative Example 2. In addition, in the liquid crystal diffraction element according to Example 2, a higher diffraction efficiency was obtained at the position of 20 mm from the left end of the liquid crystal alignment pattern than at the position of 5 mm from the left end of the liquid crystal alignment pattern.

For example, in AR glasses using a light guide plate including a diffraction element, it is preferable that the diffraction element has a diffraction efficiency that increases from one side toward the other side in at least a part (more preferably, all) of an exit diffraction element that emits light (video) to a user. By having such a structure, in a case where light propagating in the light guide plate is diffracted by the diffraction element and emitted from the light guide plate, the brightness of the emitted light can be made uniform. Accordingly, the liquid crystal diffraction element according to Example 2 is suitable as a diffraction element that makes the brightness of light emitted from the light guide plate uniform as described above, as compared with Comparative Example 2.

From the above results, the effect of Examples of the present embodiment of the present invention is clear.

The liquid crystal diffraction element according to the embodiment of the present invention can be suitably used for a head-mounted display or the like.

### EXPLANATION OF REFERENCES

18, 18A, 18B, 400: liquid crystal diffraction element
32: substrate
34: alignment film
36, 36A, 36B, 36C, 36a, 36b, 36c: cholesteric liquid crystal layer
38: liquid crystal compound
38A: optical axis
40, 64, 84: light source
42: bright portion
44: dark portion
50: optical device
60, 80: exposure device
62, 82: laser
68, 86, 94: polarization beam splitter
70A, 70B, 90A, 90B: mirror
92: lens
72A, 72B, 96, 414: λ/4 plate
110, 110A, 110B, 110C, 200, 310: image display device
112, 312: image projection element
114: retardation plate
116: transparent substrate
118: liquid crystal diffraction element
120: MEMS mirror
122, 316: light guide plate
202: image display element
204: circular polarization plate
210: optical unit
211: first partial reflection element
213: second partial reflection element
314: light guide element
318: incidence diffraction element
320: intermediate diffraction element
324: exit diffraction element
410: dove prism
412: linear polarizer

What is claimed is:

1. A liquid crystal diffraction element comprising a cholesteric liquid crystal layer,
wherein the cholesteric liquid crystal layer has a liquid crystal alignment pattern in which a direction of an optical axis derived from a liquid crystal compound changes while continuously rotating along at least one direction in-plane, and
the cholesteric liquid crystal layer has, on at least one surface of the cholesteric liquid crystal layer, a region where the liquid crystal compound has a tilt angle with respect to a surface of the cholesteric liquid crystal layer, and a region where the tilt angle of the liquid crystal compound with respect to the surface of the cholesteric liquid crystal layer differs in-plane.

2. The liquid crystal diffraction element according to claim 1,
wherein, in a case where a length over which the direction of the optical axis derived from the liquid crystal compound rotates by 180° in-plane is defined as one period, the cholesteric liquid crystal layer has a region where the length of the one period in the liquid crystal alignment pattern differs in-plane.

3. The liquid crystal diffraction element according to claim 2,
wherein the length of the one period in the liquid crystal alignment pattern gradually changes along the one direction, and
the tilt angle of the liquid crystal compound gradually changes along the one direction.

4. The liquid crystal diffraction element according to claim 3,
wherein the tilt angle of the liquid crystal compound increases along the one direction as the length of the one period in the liquid crystal alignment pattern decreases along the one direction.

5. The liquid crystal diffraction element according to claim 1,
wherein, in a cross-sectional image obtained by observing, with a scanning electron microscope, a cross section cut along the one direction and a thickness direction of the cholesteric liquid crystal layer, the cholesteric liquid crystal layer has a bright portion and a dark portion extending from one surface to the other surface, and
in the thickness direction of the cholesteric liquid crystal layer, a region where an inclination angle of the dark portion with respect to the one surface differs from the tilt angle of the liquid crystal compound is present.

6. The liquid crystal diffraction element according to claim 1, comprising at least two cholesteric liquid crystal layers,
wherein the at least two cholesteric liquid crystal layers each include
a bright portion and a dark portion that extend from one surface to the other surface in a cross-sectional image obtained by observing, with a scanning electron microscope, a cross section cut along the one direction and a thickness direction of the cholesteric liquid crystal layer, and
inclination angles of the dark portions included in the at least two cholesteric liquid crystal layers are different from each other.

7. The liquid crystal diffraction element according to claim 1,
wherein the tilt angle of the liquid crystal compound with respect to the surface of the cholesteric liquid crystal layer gradually changes in at least a part of a plane of the cholesteric liquid crystal layer.

8. A liquid crystal diffraction element comprising a cholesteric liquid crystal layer,
wherein the cholesteric liquid crystal layer has a liquid crystal alignment pattern in which a direction of an optical axis derived from the liquid crystal compound changes while continuously rotating along at least one direction in-plane, and
the cholesteric liquid crystal layer has a region where, in a case where retardation is measured from a normal direction of a main surface of the cholesteric liquid crystal layer and from a direction inclined with respect to a normal line, a direction in which the retardation is minimum is inclined with respect to the normal direction, and a region where the direction in which the retardation is minimum differs in-plane.

9. The liquid crystal diffraction element according to claim 8,
wherein, in a case where a length over which the direction of the optical axis derived from the liquid crystal compound rotates by 180° in-plane is defined as one period, the cholesteric liquid crystal layer has a region where the length of the one period in the liquid crystal alignment pattern differs in-plane.

10. The liquid crystal diffraction element according to claim 9,
wherein the length of the one period in the liquid crystal alignment pattern gradually changes along the one direction, and
an angle, from the normal direction of the main surface of the cholesteric liquid crystal layer, of the direction in which the retardation of the cholesteric liquid crystal layer is minimum gradually changes along the one direction.

11. The liquid crystal diffraction element according to claim 9,
wherein, in the liquid crystal alignment pattern, as the length of the one period decreases, an angle, from the normal direction of the main surface of the cholesteric liquid crystal layer, of the direction in which the retardation of the cholesteric liquid crystal layer is minimum increases.

12. The liquid crystal diffraction element according to claim 9,
wherein the cholesteric liquid crystal layer has a bright portion and a dark portion extending from one surface to the other surface in a cross-sectional image obtained by observing, with a scanning electron microscope, a cross section cut along the one direction and a thickness direction of the cholesteric liquid crystal layer, and
in the thickness direction of the cholesteric liquid crystal layer, a region where an inclination angle of the dark portion with respect to the one surface differs from an angle between the direction in which the retardation of the cholesteric liquid crystal layer is minimum and the normal direction of the main surface of the cholesteric liquid crystal layer is present.

13. The liquid crystal diffraction element according to claim 12, comprising at least two cholesteric liquid crystal layers,
wherein the at least two cholesteric liquid crystal layers each include
a bright portion and a dark portion that extend from one surface to the other surface in a cross-sectional image obtained by observing, with a scanning electron microscope, a cross section cut in the thickness direction along the one direction, and
inclination angles, with respect to the one surface, of the dark portions included in each of the at least two cholesteric liquid crystal layers are different from each other.

14. The liquid crystal diffraction element according to claim 8,
wherein an angle, from the normal direction of the main surface of the cholesteric liquid crystal layer, of the direction in which the retardation of the cholesteric liquid crystal layer is minimum gradually changes in-plane of the cholesteric liquid crystal layer.

15. An optical device comprising:
the liquid crystal diffraction element according to claim 1; and
a light source that emits light to be incident on the liquid crystal diffraction element.

16. An optical device comprising:
the liquid crystal diffraction element according to claim 1; and
a light source that emits light to be incident on the liquid crystal diffraction element,
wherein, in a case where an angle of light incident on the liquid crystal diffraction element from the light source is defined as θin, an emission angle of first-order light reflected from the liquid crystal diffraction element is defined as θm, and a refractive index of the cholesteric liquid crystal layer is defined as nG, a tilt angle θP [°] of the liquid crystal compound satisfies the following expressions (A1) to (A3),
$$θ P [ ° ] = ( θ G [ ° ] - θ r [ ° ] ) / 2 \pm 15 [ ° ] , \qquad ( A1 )$$
$$sin θ G = sin θ m / nG , \\ and \qquad ( A2 )$$
$$sin θ r = sin θ in / nG . \qquad ( A3 )$$

17. An optical device comprising:
the liquid crystal diffraction element according to claim 8; and
a light source that emits light to be incident on the liquid crystal diffraction element,
wherein, in a case where an angle of light incident on the liquid crystal diffraction element from the light source is θin, an emission angle of first-order light emitted from the liquid crystal diffraction element is θm, and a refractive index of the cholesteric liquid crystal layer is nG, an angle θ2 [°] between a direction D_{R} in which a retardation of the cholesteric liquid crystal layer is minimum and a normal direction of a main surface of the cholesteric liquid crystal layer satisfies the following expressions (B1) to (B3),
$$θ2 [ ° ] = ( θ G [ ° ] - θ r [ ° ] ) / 2 \pm 15 [ ° ] , \qquad ( B1 )$$
$$sin θ G = sin θ m / nG , \\ and \qquad ( B2 )$$
$$sin θ r = sin θ in / nG . \qquad ( B3 )$$

18. The liquid crystal diffraction element according to claim 2,
wherein, in a cross-sectional image obtained by observing, with a scanning electron microscope, a cross section cut along the one direction and a thickness direction of the cholesteric liquid crystal layer, the cholesteric liquid crystal layer has a bright portion and a dark portion extending from one surface to the other surface, and
in the thickness direction of the cholesteric liquid crystal layer, a region where an inclination angle of the dark portion with respect to the one surface differs from the tilt angle of the liquid crystal compound is present.

19. The liquid crystal diffraction element according to claim 2, comprising at least two cholesteric liquid crystal layers,
wherein the at least two cholesteric liquid crystal layers each include
a bright portion and a dark portion that extend from one surface to the other surface in a cross-sectional image obtained by observing, with a scanning electron microscope, a cross section cut along the one direction and a thickness direction of the cholesteric liquid crystal layer, and
inclination angles of the dark portions included in the at least two cholesteric liquid crystal layers are different from each other.

20. The liquid crystal diffraction element according to claim 10,
wherein, in the liquid crystal alignment pattern, as the length of the one period decreases, an angle, from the normal direction of the main surface of the cholesteric liquid crystal layer, of the direction in which the retardation of the cholesteric liquid crystal layer is minimum increases.
